(19) United States
(12) Patent Application Publication
(10) Pub. No.: US 2019/0385114 A1
(43) Pub. Date: Dec. 19, 2019

(54) SYSTEMS, METHODS AND APPARATUSES FOR MANAGING PLANT QUARANTINES

(71) Applicant: William Daniel Willey, Morgan Hill, CA (US)

(72) Inventor: William Daniel Willey, Morgan Hill, CA (US)

(21) Appl. No.: 16/099,164

(22) PCT Filed: May 3, 2017
(86) PCT No.: PCT/IB2017/000791

§ 371 Date: Nov. 5, 2018

Related U.S. Application Data
(60) Provisional application No. 62/331,334, filed on May 3, 2016.

(51) Int. Cl. G06Q 10/08; G06Q 10/06; G06F 16/955; G06F 16/9538; G06K 7/10

(52) U.S. Cl. CPC G06Q 10/087; G06Q 10/0635; G06K 7/10138; G06F 16/9538; G06F 16/9558

(57) ABSTRACT

Systems, methods and apparatuses for managing plant quarantines are provided, including quarantine tags that are utilized with plant-specific and user-specific electronic information to aid in notification, tracking, education, enforcement and compliance with a quarantine zone and rules for a plant quarantine. The quarantine tag includes text, symbols, images, colors, computer-readable codes and other information designed to help a user quickly and easily identify plant-specific and user-specific information related to a quarantine, including hyperlinks to electronic data accessible via a portable electronic device which provides and tracks location-specific, quarantine-specific and user-specific information to improve compliance and enforcement of the quarantine zone and prevent the spread of disease in cultivated plants. The user may be continuously provided with quarantine information on the device through an application which will aid the user in complying with the quarantine after acquiring a plant.

### BACKGROUND

### Field of the Invention

Systems, methods and apparatuses provided herein relate to tags for quarantined plants, and more specifically to tags and related systems and methods for using the tags and user-specific electronic data to notify, track, inform and educate consumers about a quarantine zone to improve compliance and enforcement of the quarantine zones and prevent the spread of disease in cultivated plants.

### Related Art

In recent years, huanglongbing (also known as HLB and citrus greening disease), the most deadly disease of citrus trees, has been spreading rapidly throughout the world. HLB is a bacterial disease of citrus. In the absence of HLB, citrus trees can live to be hundreds of years old. When infected with HLB, trees have a very short life expectancy and begin to produce bad-tasting bitter fruit. There is no cure for HLB.

Insects known as Asian citrus psyllids (sometimes abbreviated ACP) that transmit the disease from one tree to another have also been spreading rapidly throughout the world. In the absence of HLB, Asian citrus psyllids are a minor nuisance and cause little damage. When a citrus tree is infected with HLB and an Asian citrus psyllid feeds on the tree, the psyllid can ingest the bacteria, fly to an uninfected tree and feed on it, spreading HLB to the uninfected tree. A single female psyllid carrying HLB can cause a devastating disease outbreak by feeding upon a tree and thus infecting it and then laying eggs on the tree close to the site of feeding. The infection spreads locally and meanwhile the eggs hatch and develop into nymphs. The nymphs feed on the newly-infected vegetation and acquire the HLB bacteria. When they develop into adults, they fly away and can infect other trees with HLB.

HLB in the absence of citrus psyllids is not easily spread from tree to tree. HLB can be spread from one citrus tree to another by the grafting of infected budwood, however. Also, if new citrus trees are vegetatively propagated from HLB-infected source trees, they will also be infected with HLB, Such as when people from parts of the world where HLB exists move to other parts of the world. Due to the threat of diseases, many countries and states have laws that prohibit the entry of citrus budwood from other parts of the world except through certain programs where the budwood is quarantined and diseases are removed before the introduction of a variety. Immigrants sometimes are unaware of the laws, however, and move HLB-infected budwood to new areas. So HLB-infected citrus trees may be present in areas where citrus psyllids do not exist.

HLB is a new bacterial disease of citrus that originated relatively recently. There are a number of strains of the disease including: strains that originated in Asia (called Candidatus Liberibacter asiaticus, or sometimes Las or LAS), another form that originated in Africa (called Candidatus Liberibacter africanus), and another form that was first discovered in Brazil (called Candidatus Liberibacter americanus). At least two types of citrus psyllids transmit the disease, including: one that originated in Asia (the Asian citrus psyllid or Diaphorina citri or D. citri) and another that originated in Africa (the African citrus psyllid or Trioza erytreae). By the end of the 20th century, HLB was widespread in Asia, greatly reducing the life expectancy of citrus trees in Asia. Asian citrus psyllids were first detected in Brazil in 1942. The psyllids arrived in Brazil without the disease and spread in South America as a minor nuisance for many years. HLB was first detected in Brazil in 2004 and quickly spread with devastating results. Asian citrus psyllids first arrived in Florida in 1998. HLB was first detected in Florida in 2005 in Miami. HLB spread much more rapidly in Florida than in Brazil due to the shipment from Miami of large numbers of plants all over the state infested with Asian citrus psyllids. These included not only infested citrus plants but also citrus relatives such as orange Jessamine (Murraya paniculata) and Indian curry leaf trees (Murraya koenigii) that serve as hosts for psyllids and that were infested with HLB-positive psyllids.

In Florida, HLB has spread to all citrus producing counties, killing millions of citrus trees and causing a large reduction in the amount of citrus fruit produced. The economic loss in Florida has been billions of dollars and thousands of citrus-related jobs have been lost.

Asian citrus psyllids crossed the border into California from Mexico in 2008. These initial psyllids were free from HLB. The experience in Florida caused changes in Citrus nursery tree production in California intended to make the spread of ACP and HLB less likely. In California citrus trees are now grafted by citrus production nurseries in insect-proof structures using registered budwood from source trees that have been tested and shown to be free of diseases such as HLB. Before they are shipped to retail nurseries for sale, citrus trees are treated with systemic insecticides. The citrus trees are shipped to retail nurseries in sealed containers.

At retail nurseries, citrus trees are typically kept outdoors, however. Psyllids from neighboring areas are naturally attracted to new growth of citrus trees at the retail nursery and will fly to the new growth to feed. For newly-delivered trees, the insecticide that was applied at the production nursery will kill feeding psyllids quickly and reduce the likelihood of infection by HLB-positive psyllids. If a citrus tree at a retail nursery remains unsold, the concentration of insecticide in the plant declines as watering washes out the insecticide and as the tree grows. Within a few months, the insecticide drops to a level that is no longer lethal to psyllids and the citrus tree may be infested with psyllids. The infestation may include psyllid eggs on the plant as well as nymphs and adult psyllids. Psyllids are so small that they are unlikely to be noticed by most people. If any of the psyllids are HLB-positive, the tree may become infected. Movement of a plant infested with psyllids to a location where psyllids were not present creates the potential for a disease outbreak, especially if HLB is present in a citrus tree in the new location. Furthermore, psyllids may fly off the tree anywhere along the route and cause a new infestation. Similarly, movement of a plant infected with HLB or infested with HLB-positive psyllids can cause a disease outbreak all by itself.

In California retail citrus nurseries, it is common for trees to remain unsold long enough for the insecticide applied at the production nursery to become ineffective. One option to prevent trees at retail nurseries from becoming infested with citrus psyllids is to periodically retreat the trees with insecticide before the insecticide wears off. Due to the expense of retreatment, it is uncommon for trees at retail nurseries in California to be retreated, however. Another option to prevent trees at retail nurseries from becoming infested with citrus psyllids is to keep the trees inside of a screened insect-resistant structure. Due to the expense, retail nurseries do not commonly use these structures.

For a period of time, the California Department of Food and Agriculture (CDFA) had a team of around 20 inspectors visiting retail nurseries in Southern California looking for citrus trees infested with Asian Citrus Psyllids. When the inspectors found infested citrus trees they eliminated the infestations. However, citrus trees in the retail nurseries quickly became reinfested by psyllids flying in from the neighborhoods surrounding the nurseries. The inspectors were expensive and they were eventually fired due to state budget cutbacks.

As Asian citrus psyllids were detected in California, quarantines were put in place to limit the spread of the insects to new parts of the state. Maps are provided by the USDA and other agencies showing the border of the quarantines.

According to the quarantines, citrus plants and other hosts for Asian Citrus Psyllids are not allowed to move outside of a quarantined area. In order for a quarantine to be effective, it is necessary to inform people of the quarantine. It is now required that citrus trees (and other hosts for ACP) sold inside of California Asian Citrus Psyllid quarantine zones include a tag that tells potential buyers that the “plant shall not be moved out of the area quarantined for Asian Citrus Psyllid.” FIG. 1 shows some related art examples of such tags from California.

Despite the quarantine tags on the citrus trees for sale in areas quarantined for Asian Citrus Psyllids, ACPs have been moving very quickly to new areas of California much faster than the insects can fly on their own. In the past two years, Asian Citrus Psyllids have been found in many parts of Northern California far from the infested areas in Southern California. One of the most common ways that citrus psyllids move is via infested nursery trees. Many citrus varieties that cannot be found in retail nurseries in Northern California can be found in retail nurseries in Southern California, and it is known that people sometimes move trees of unusual varieties long distances. The existing quarantine tags have clearly failed to prevent the movement of citrus trees and citrus psyllids outside of the quarantined areas. Thus, a deficiency exists in the existing California quarantine tags.

One problem with the existing California quarantine tags is that they look similar to tags that can commonly be found on plants but which serve different purposes. For example, there are commonly tags on plants that indicate things such as rootstock variety that are not very important and which are ignored by many people. The existing California quarantine tags could be mistaken for other tags such as rootstock tags and thus be ignored by people who need to be informed of the quarantine.

Another problem with the existing California quarantine tags is that they only include information in two languages, English and Spanish. Although English and Spanish are the most common languages in California, there are many people in California who love citrus fruit and citrus trees who speak neither English nor Spanish. Table 1 (below) shows the numbers of people in California reported in a recent census to speak English “not well” or “not at all”. The lack of other languages on the existing quarantine tags is a deficiency that can lead to the spread of citrus psyllids and HLB.

| | How many in |
|---|---|
| Language | California speak English “not well” or “not at all” |
| Spanish | 2,834,496 |
| Vietnamese | 159,831 |
| Chinese | 153,166 |
| Korean | 121,097 |
| Cantonese | 87,441 |
| Tagalog | 56,623 |
| Armenian | 45,787 |
| Mandarin | 44,262 |
| Russian | 35,385 |
| Persian | 30,526 |
| Japanese | 28,053 |
| Punjabi | 23,128 |
| Mon-Khmer | 22,921 |
| Hmong | 16,882 |
| Arabic | 16,780 |
| Thai | 11,242 |
| Portuguese | 11,199 |
| Laotian | 9,359 |
| Formosan | 8,443 |

One of the first places in Northern California where the Asian Citrus Psyllid was discovered was in a part of San Jose whose census records indicate have the largest percentage of Vietnamese people in San Jose. More than a million dollars has been spent in an attempt to eradicate the population of Asian Citrus Psyllids in San Jose. Thus, the use of only English and Spanish on the California quarantine tags may be ineffective in preventing the spread of Asian Citrus Psyllids from Southern California to San Jose. This may have led to money being unnecessarily spent on pesticides and the spread of HLB.

Even with the two languages on the existing California quarantine tags, there is a further problem in that the languages are on opposite sides of the tag when it is attached to the plant. In some cases the tag may be placed so that only one side of the tag is visible and one of the languages is obscured. FIG. 2 is a picture taken of a tag found in a nursery where the Spanish side of the tag was not visible. Therefore, the design and content of the tag may contribute to the inadvertent spread of citrus psyllids and HLB.

Furthermore, there may be illiterate people in California who love citrus fruit and citrus trees. An illiterate person could move citrus psyllids and HLB out of a quarantined area and into the San Joaquin Valley. The current quarantine tags in California are additionally deficient in that based upon the quarantine tag, an illiterate person would not understand the restrictions for moving the citrus trees outside of the quarantined area.

Penetration of mobile communication devices such as smartphones is now very high and getting higher. Most purchasers of citrus trees in California have smartphones with them when looking at citrus trees at a retail nursery. The smartphone offers an opportunity to show a customer a map of the quarantined area and thus help avoid the spread of citrus psyllids and HLB. However, yet another problem with the existing quarantine tags is with the website URL on the tags, which is usually long and tedious for a user to type in with a smartphone. For example, one URL used on a quarantine tag is: www.cdfa.ca.gov/phpps/acp/index.html, which is 36 characters long. This is so long as to deter people from entering it on smartphones. The most popular smartphones such as iPhones now use touch-based virtual keyboard that make entry of long URLs tedious and prone to errors. Many virtual keyboards such as the one on the iPhone require extra steps to enter the “/” character which is included three times in the URL on the current California quarantine tags. Because the URL is so difficult to enter on a smartphone, people will not be inclined to go to the website, making it more likely that the quarantine will be ignored and that Asian Citrus Psyllids and HLB will spread.

Yet another problem with the existing California quarantine tag is that the same URL is used for both the English part of the tag and also for the Spanish part of the tag. So even if a Spanish-speaking customer were to enter the entire URL from the Spanish side of the existing quarantine tag, he or she would be directed to the English-language website. At the moment, there is no Spanish language web page corresponding to the English language web page.

Still another problem with the URL on the existing California quarantine tag is that the characters of the URL on the tag are smaller and less prominent than the other characters on the quarantine tag. Because the URL is not prominent, users are less likely to notice it and enter it on smartphones before purchasing the plant.

Asian Citrus Psyllids have been present in Texas since 2001. In 2012 HLB was first detected in Texas in a farm near the border with Mexico. The disease spread quickly. Citrus production nurseries in Texas were slow to adopt insect-resistant structures. In 2013, more than 10,000 citrus trees that were outside of insect-resistant structures were shipped to Houston from a nursery near the border with Mexico in an area quarantined for citrus psyllids, but outside of the area quarantined for HLB. More than 5,000 of those trees were sold to homeowners. Many of the remaining trees tested positive for HLB in Houston nurseries. The initial HLB finds in Houston were in Harris County, and Harris County was quarantined for HLB. FIG. 3 is a picture of a tag placed on citrus trees in Harris County in response to the HLB quarantine. Both sides of the tag were in English, a deficiency that can lead to the inadvertent spread of HLB by people who cannot read English.

FIG. 4 is a photo of a current quarantine tag from McAllen, Tex. in an area quarantined for HLB. In some aspects the McAllen, Tex. quarantine tag shows improvement over the California quarantine tag. The McAllen tag also has a URL, but it lacks the “/” character which is difficult to type. However, like the California tag, the URL is unnecessarily long. “TexasAgriculture.gov” is 20 characters long and is tedious to enter on a touch-based virtual keyboard. In McAllen, Tex. there are many people who speak no English, but the tag only has English. The back of the tag is blank.

FIG. 5 illustrates two photos of a front side and back side of an HLB quarantine tag from a nursery in Miami, Fla. The current quarantine tags in Florida are deficient for multiple reasons already noted with the California and Texas quarantine tags. Yet another deficiency with the tags is that there are parts of Florida where HLB has not yet been detected. Although this quarantine tag may discourage English speakers from moving the tree to another state, it would not discourage people from moving the tree to another part of Florida where HLB has not yet been detected.

Problems With the Websites

In addition to the deficiencies with the California citrus plant quarantine tags, there are also deficiencies with the website to which the URL on the quarantine tags leads. FIG. 6 shows a screen capture taken on an iPhone 6 of the web page to which the URL on the California quarantine tags leads.

The problem with this web page is that it is not readily apparent to any person as to how to respect the quarantine or find the quarantine information. There are more than fifty clickable links, and only two of them lead the user in the right direction. Many users are likely to give up and end up violating the quarantine because the information is not readily apparent.

FIG. 7 shows a view after the user clicks one of the two links about quarantines. The correct information is still not readily available. The user must choose the correct one of fourteen newly-shown links to be led to the following web page illustrated in FIG. 8. After two clicks the quarantine information is still not readily available. Clicking the first link, “ACP State Interior Quarantine” leads to a PDF document that still does not make the correct information apparent, as shown in FIG. 9. By scrolling through the entire file and switching back and forth with a map application such as Google Maps, the user may eventually be able to figure out where the plant can be moved, but most users would tend to give up. Giving up comes with the risk of spreading Asian Citrus Psyllids and HLB outside of the quarantined area.

In addition to the deficiencies with the Texas citrus plant quarantine tags, there are also deficiencies with the website to which the URL on the quarantine tags leads. FIG. 10A shows a screen capture taken on an iPhone 6 of the web page to which the URL on the Texas quarantine tags leads. As with the California website, the Texas website has a large number of links such that the quarantine information is not readily apparent. After following the correct link, the user arrives at the webpage shown in FIG. 10B. The “CLICK HERE” phrase on the link in FIG. 10B leads to the map illustrated in FIG. 11. Although easier to understand than the California website, this web page is still not perfectly clear, especially because there are two geographically separated and unconnected areas that are quarantined for HLB. Quarantines are a technical topic that ordinary people do not commonly think about and the existence of multiple quarantined areas makes it harder to understand. Without the language on the quarantine tag, the map on the web page might give a person the impression that it would be permissible to move a citrus tree from one of the areas to the other area. If a person were to misunderstand this map and move a citrus tree infested with HLB-positive psyllids from one quarantined region to the other, an infested psyllid could blow off the tree along the way and cause a new outbreak of HLB in between the two regions.

It should be noted that the Texas quarantine and website is only dealing with an HLB quarantine. The entire state of Texas has been quarantined for Asian citrus psyllids, so the restrictions on movement of citrus plants on the website are for the HLB quarantine and not for a psyllid quarantine.

As an additional example, African citrus psyllids have been discovered in northwestern Spain, and the area where they are known to exist has been quarantined. FIG. 12 shows an example of a tag placed on a quarantined tree in northwestern Spain. The problems with the illustrated tag are evident.

Problem with Current Quarantine Scheme—Risk of HLB

There is yet another problem with the current quarantine scheme in California. As of April 2016, there are two types of quarantines designed to limit the spread of Asian Citrus Psyllids and HLB. The first type of quarantine is the quarantine for Asian Citrus Psyllids. There are many areas of California quarantined for Asian Citrus Psyllids, as seen in the map in FIG. 13A. The second type of quarantine is the quarantine for HLB. There is a single area in California that has been quarantined for HLB, as shown in FIG. 13B. HLB has been detected in Hacienda Heights, Calif. and in San Gabriel, Calif. and these areas have been quarantined. Currently in the parts of California quarantined for HLB, the threat of disease spread is so severe that the sale of citrus trees from retail nurseries is prohibited. However, nurseries have requested the ability to sell trees from within the HLB quarantined area.

The United States Department of Agriculture (USDA) determined the test used to confirm HLB in plant tissue samples and in psyllid samples. The USDA-approved HLB test uses a Polymerase chain reaction (PCR) DNA test to detect DNA of the HLB bacteria in the plant or psyllid samples. The PCR test uses a number of DNA amplification cycles, and if the DNA of an HLB bacteria is detected within a certain number of cycles (cycle threshold or Ct), then the test is considered positive for HLB. If the DNA is not detected within the number of cycles specified by the USDA, the test is considered either inconclusive or negative based upon the Ct level where the DNA is detected or not detected after the maximum number of cycles.

The USDA HLB test does not work well for a number of reasons. One reason is that it can take a long time for the HLB bacteria to spread to the whole tree. When initially infected, there may be only a single branch of a tree infected, so if a tissue sample comes from an uninfected branch, then the test may give a negative result even if the tree is infected. Because of this, a tree may be infectious and spreading HLB long before the disease can be detected and the tree removed. Because of this long latency period there may be areas with HLB that are not currently quarantined for HLB even though there have been surveys and tests of trees in those areas.

It now appears that another reason that the USDA HLB test does not work well is that the USDA chose too low of a Ct threshold value for a positive test (Ct of 33 or below). Dr. David Bartels, a scientist from Texas, performed studies of the geographical distribution of USDA inconclusive test results (Ct of 34 to 38) in Texas and observed that outbreaks of HLB in particular locations followed clusters of USDA test results in the inconclusive range in those locations. Inconclusive results have also been observed in California outside of the areas quarantined for HLB. Because the USDA has not updated the Ct threshold, it would appear that there are already other areas in California with HLB present that are not currently quarantined for HLB. The map in FIG. 14 shows locations where samples were collected whose test results showed Ct values in the inconclusive range. Clusters of these locations may be indicative of HLB infection.

Scientists are also developing a new test for HLB based upon other technologies such as soluble metabolites, volatile metabolites, protein assays, small RNAs, and optical imaging.

Scientists have also created mathematical models for risk of HLB in various geographic areas of California based upon various input variables such as:

Risk due to potential ACP spread,

Risk due to known ACP population prevalence and dynamics,

Transportation corridors,

Climatological effects,

Population demographics based on census data (including connections to countries where HLB exists),

Risk from trees that have been confirmed HLB-positive based upon a test such as a PCR test, and

Risk based upon HLB test results from other testing technologies.

Yet another input variable could be locations where plant or insect samples were collected whose PCR DNA test results showed Ct values in the inconclusive range.

To date these mathematical models have been used to determine sampling locations for surveyors to collect plant samples and psyllid samples for testing. A positive test result for plant tissue can result in the removal of a tree so that the diseased tree does not act as a source for further infections. A positive test result for a psyllid sample would typically trigger more intensive surveys and tests of plant tissue samples collected near the location where the psyllid was collected.

Further details of the mathematical models for risk of HLB can be found in the Spring 2014 Citrograph Magazine:

http://www.imok.ufl.edu/hlb/database/pdf/17_citograph12_14.pdf and also here:

http://ccuh.ucdavis.edu/Events/copy_of_public/current-issues-in-invasive-emerging-pests-diseases/asian-citrus-psyllid-huanglonging-dr-neil-mcroberts.

Meanwhile, citrus psyllids have been spreading more and more and now exist in most of Southern California. Initially after psyllids were detected in California and areas were quarantined for the psyllids, the psyllid-quarantined areas were small and were useful in that they limited not only the movement of trees possibly infested with psyllids, but also the movement of trees possibly infected with HLB. As the psyllids have spread, the area quarantined for psyllids has grown, creating a larger area where trees could be freely moved after purchase. Because of the aforementioned problems in detecting HLB, the movement of citrus trees from areas infested with psyllids is a significant problem. Free movement of plants that may be infected with HLB or infested with HLB-positive psyllids could lead to the rapid spread of HLB. Based upon the observed rate of the spread of the psyllid, they could cover the entire state of California in the near future.

A future where the entire state of California is quarantined for the Asian Citrus Psyllid has been contemplated. In that event, one suggestion that has been made is to divide the state into a number of smaller zones (e.g. 4 or 5). Within those zones citrus trees would be allowed to move freely after sale from a retail nursery, but they would not be allowed to move outside of the zone in which they were purchased. One of the proposed zones would be for the San Joaquin valley. The thinking is to isolate the San Joaquin valley (and the majority of the citrus industry) from some of the other parts of California, such as Los Angeles, that are a large threat for HLB. Because of the difficulty in detecting HLB, this would still allow for rapid movement of the disease over large areas of the state, however. The disease could rapidly move to the edges of the smaller zones, cross the zone boundaries, and then spread to the heart of the San Joaquin valley, devastating the California citrus industry. Although the proposed multizone statewide quarantine scheme would provide some improvement over a statewide quarantine where trees could be moved freely throughout parts of the state quarantined for ACP but not HLB, there could still be long distance movement of HLB. So there are deficiencies in the suggested multi-zone statewide quarantine scheme. It would be desirable to have a quarantine scheme where the spread of HLB could be reduced or eliminated.

Furthermore, HLB is now also a threat in Continental Europe due to the recent discovery of the African Citrus Psyllid, another vector of the disease, in northwestern Spain and northern Portugal. African Citrus Psyllids are similar to Asian Citrus Psyllids and have been shown to transmit all forms of HLB.

Although neither Asian Citrus Psyllids nor African Citrus Psyllids have been found infesting citrus trees in Australia, biosecurity officers at the Melbourne Airport seized leaves and roots of curry leaf trees infested with eggs and nymphs of Asian Citrus Psyllids. So Australia could be faced with the same problems seen in California and in Europe. South America and Africa also have infestations of citrus psyllids and areas where HLB is present.

In addition, many other diseases of citrus exist that are unevenly distributed on Earth; some examples are Sweet Orange Scab, Australian citrus dieback, bacterial canker, bacterial spot, blast and black pit, citrus variegated chlorosis, stubborn, witches' broom, psorosis, tristeza, citrus variegation virus, citrus crinkly leaf virus, citrus leaf rugose virus, concave gum and blind pocket, citrus tatter leaf virus, vein enation, cachexia, exocortis, satsuma dwarf virus, citrus black spot, citrus yellow mosaic virus, and mal secco. There are also many other insects that infest citrus that are unevenly distributed on Earth; some examples are brown citrus aphid, Caribbean fruit fly, Mexican fruit fly, Mediterranean fruit fly, Oriental fruit fly, guava fruit fly, melon fly, Queensland fruit fly, golden headed weevil, spined citrus bug, Sri Lanka weevil, Asian cockroach, Chinese citrus fly, cottony citrus scale, citrus snow scale, fruit piercing moth, plague thrips, and citrus gall wasps. As these diseases and insects spread, improvements in quarantine tags, methods of informing people of quarantines, and methods to implement quarantines are desirable.

Yet another problem is that there can be overlapping quarantined areas when multiple quarantine conditions such as insects and diseases are present in a geographic area. At the moment, the quarantine for a single insect, the Asian citrus psyllid, is so complex as to make it difficult for a customer in a retail nursery to understand where a citrus tree can be moved. The existing technology for informing a user where a plant can be moved only takes into account one type of quarantine. If another quarantine for another insect or disease were present at the same time, it would be much more difficult for a customer to understand where a plant could be moved. An example of such a situation would be the combination of Sweet Orange Scab and Asian citrus psyllid in a certain geographic location. Another example of such a situation would be the combination of Asian citrus psyllid and citrus canker. Yet another example of such a situation would be the combination of Asian citrus psyllid and African citrus psyllid. There could even be more complex scenarios with more than two overlapping quarantined areas. As a result, improvements in quarantine tags, methods of informing people of quarantines, and methods to implement quarantines are desirable.

There are also many other types of plants that are vulnerable to many diseases and many types of pests such as insects that are unevenly distributed on Earth. For example, the European Grapevine Moth is infesting grape vines in portions of California's Napa Valley. The Guava Fruit Fly is an exotic pest established in some parts of the world, but not the continental United States; establishment of this fly in the United States would cause economic loss, increased pesticide use, and damaged fruit. The Light Brown Apple moth (LBAM) is originally from Australia and is now established in New Zealand, New Caledonia, Hawaii, the British Isles, and in thirteen counties in California; LBAM damages fruit. The Malaysian Fruit Fly is present in Asia, has invaded Hawaii, and its establishment in California would cause considerable damage to more than 59 types of fruits and vegetables that are worth billions of dollars annually in California. Another pest of fruit in California currently under quarantine is the Melon fruit fly, Bactrocera cucurbitae. There are many other diseases and types of pests such as insects distributed unevenly in the world. Migration of people makes movement and spread of these many insects and diseases more and more of a problem, creating the need for improvements in quarantine tags, methods of informing people of quarantines, and methods to implement quarantines.

### SUMMARY

Embodiments described herein provide for systems, methods and apparatuses such as quarantine tags that are utilized with plant-specific and user-specific electronic information to aid in notification, tracking, education, enforcement and compliance with a quarantine zone and rules for a plant quarantine. The quarantine tag may include text, symbols, images, colors, computer-readable codes and other information designed to help a user quickly and easily identify plant-specific and user-specific information related to a quarantine, including hyperlinks to electronic data accessible via a portable electronic device which provides and tracks location-specific, quarantine-specific and user-specific information to improve compliance and enforcement of the quarantine zone and prevent the spread of disease in cultivated plants. The user may be continuously provided with quarantine information on the portable electronic device through an application or browser which will continue to aid a user in complying with the quarantine after acquiring a specific plant.

In one embodiment, a quarantine tag system comprises a quarantine tag with an informational link and a portable electronic device which receives the informational link and accesses quarantine information which is combined with user-specific information from the portable electronic device to display user-specific quarantine information to the user via the portable electronic device.

In a further embodiment, a quarantine tag comprises content related to a plant quarantine, at least one of a symbol, image, shape or color relating to the plant quarantine, and at least one informational link which directs a user to electronic information related to the plant quarantine.

Other features and advantages of the present invention will become more readily apparent to those of ordinary skill in the art after reviewing the following detailed description and accompanying drawings.

### BRIEF DESCRIPTION OF THE DRAWINGS

The structure and operation of the present invention will be understood from a review of the following detailed description and the accompanying drawings in which like reference numerals refer to like parts and in which:

FIGS. 1-5 are images of quarantine tags, as is known in the art;

FIGS. 6-10B are images of web pages which provide quarantine information, as is known in the art;

FIG. 11 is an image of a quarantine map, as is known in the art;

FIG. 12 is an image of a quarantine tag used in Spain, as is known in the art;

FIGS. 13-14 are images of quarantine maps, as are known in the art;

FIGS. 15-18 are images of quarantine tags, according to one embodiment of the invention;

FIG. 19 is an image of a quarantine map viewed on a mobile browser, as is known in the art;

FIG. 20-24B are images of quarantine maps, according to one embodiment of the invention;

FIGS. 25A-D are Venn diagrams illustrating overlapping quarantine areas, according to one embodiment of the invention;

FIG. 26 is an exemplary system for providing user-specific quarantine information, according to one embodiment of the invention;

FIG. 27 is a flow diagram illustrating an example process for providing user-specific quarantine information, according to an embodiment of the invention;

FIG. 28 is a block diagram illustrating an example wired or wireless processor enabled device that may be used in connection with various embodiments described herein;

FIG. 29 is a flow diagram illustrating an example process for generating user-specific quarantine information, according to an embodiment of the invention; and

FIGS. 30A-30C are additional images of quarantine maps, according to one embodiment of the invention.

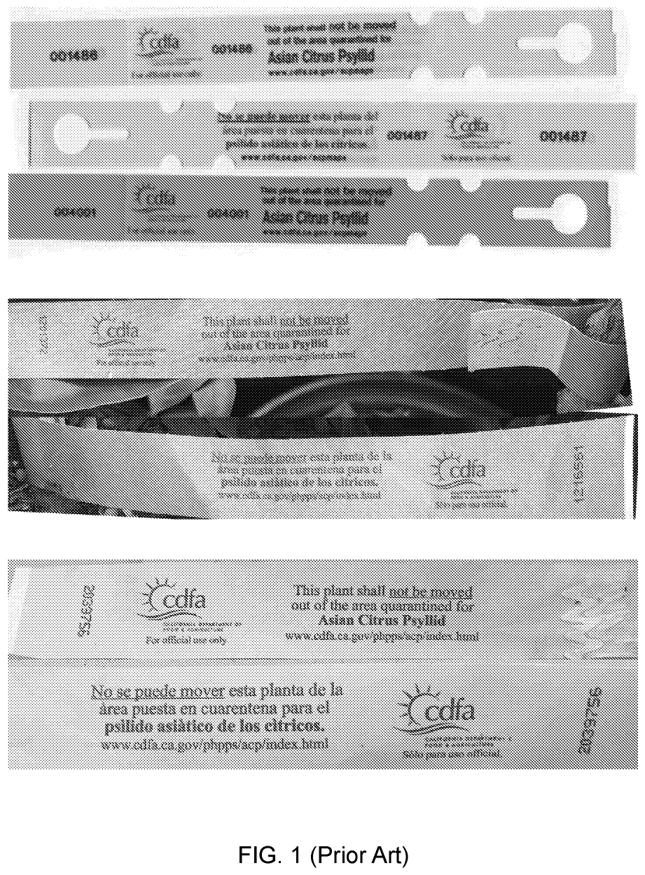

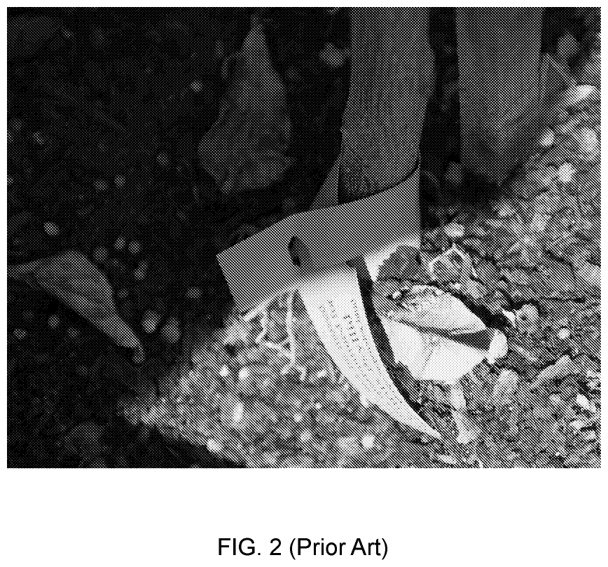

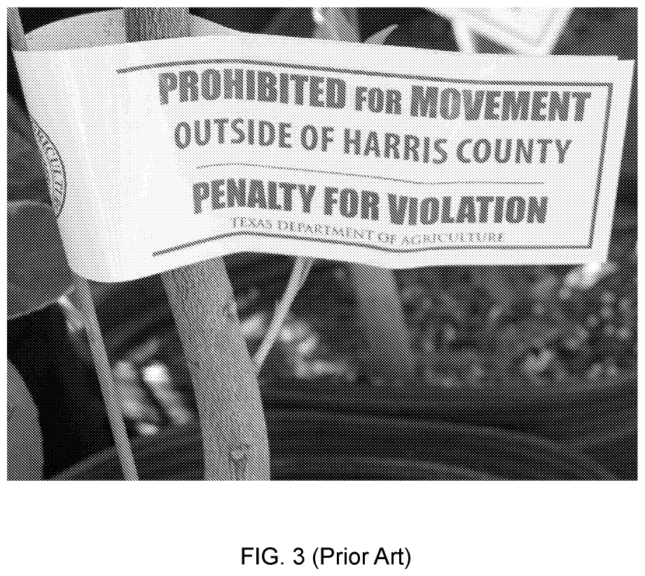

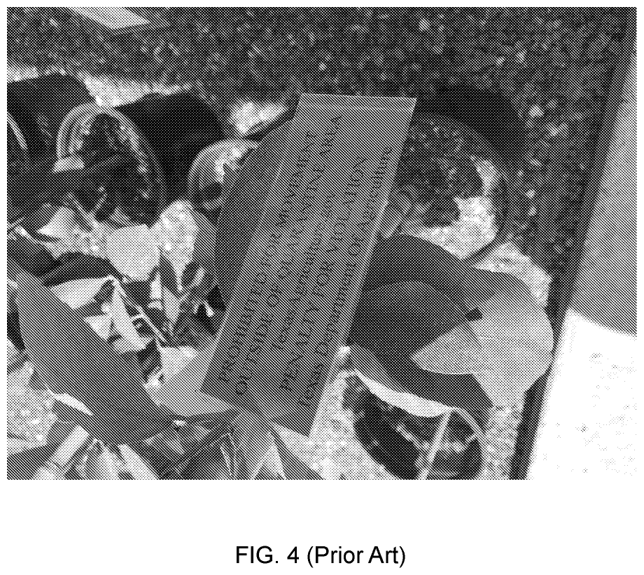

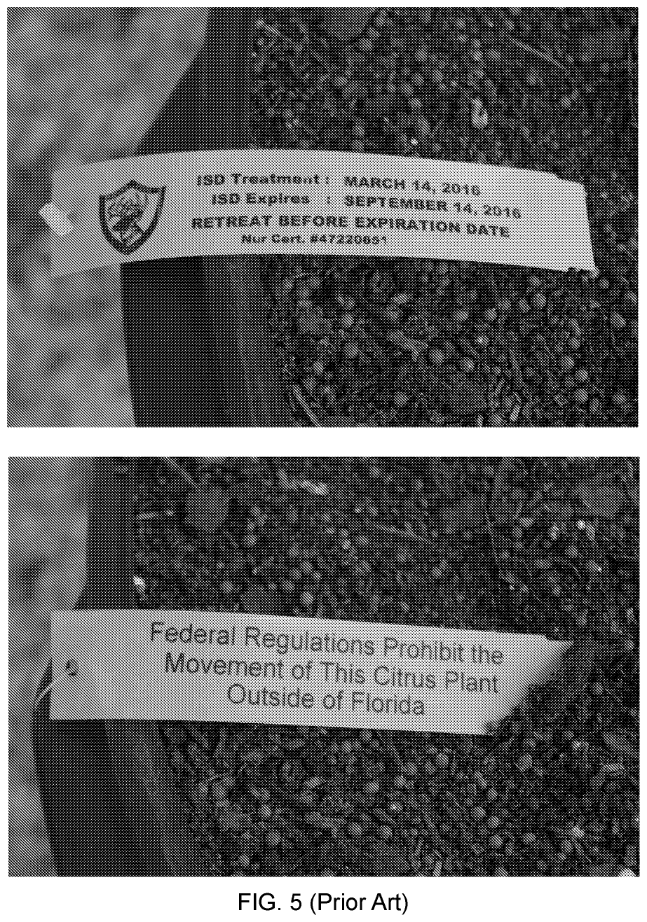

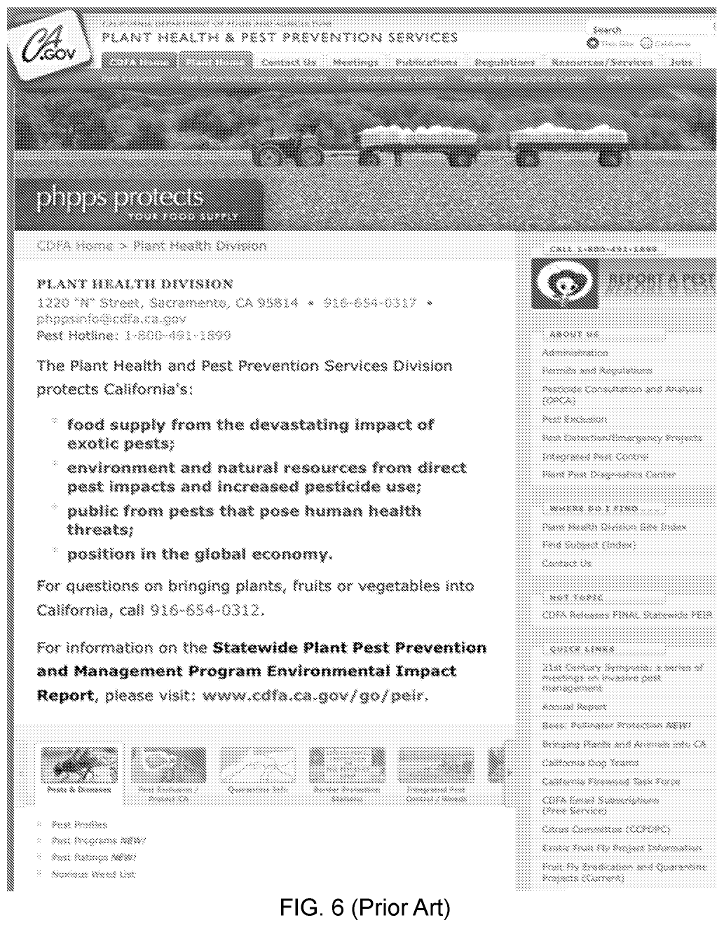

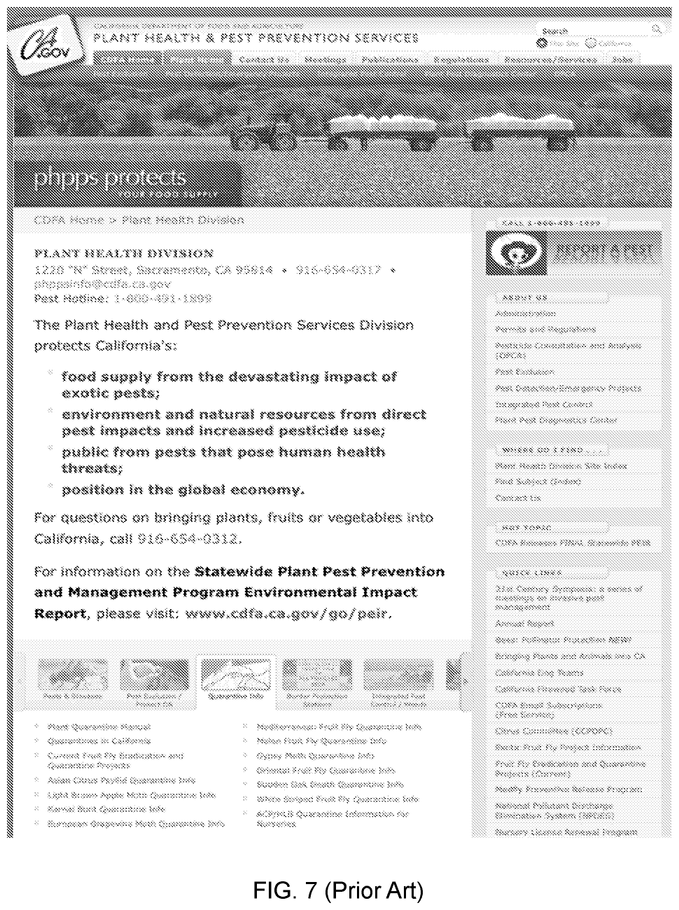

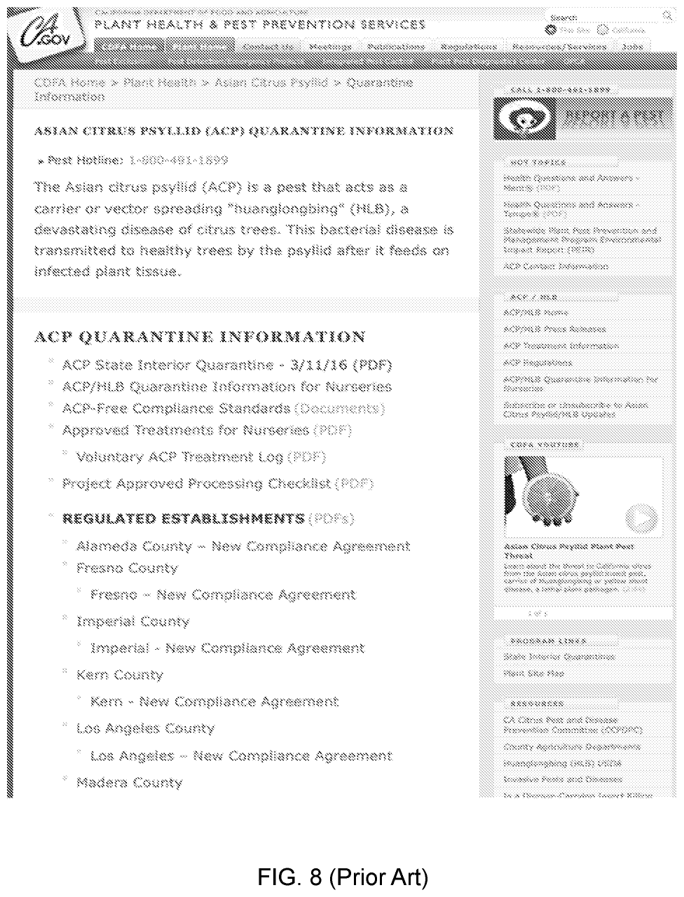

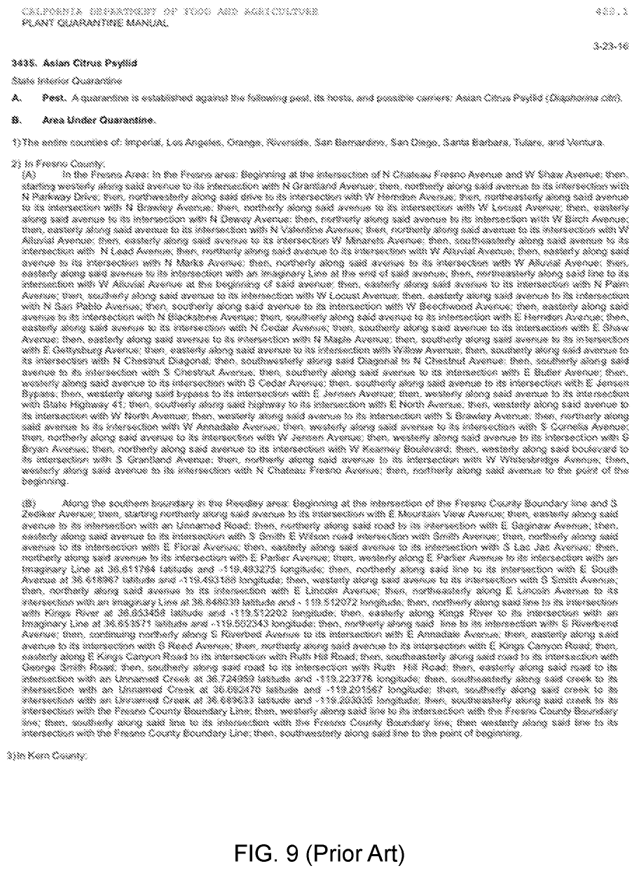

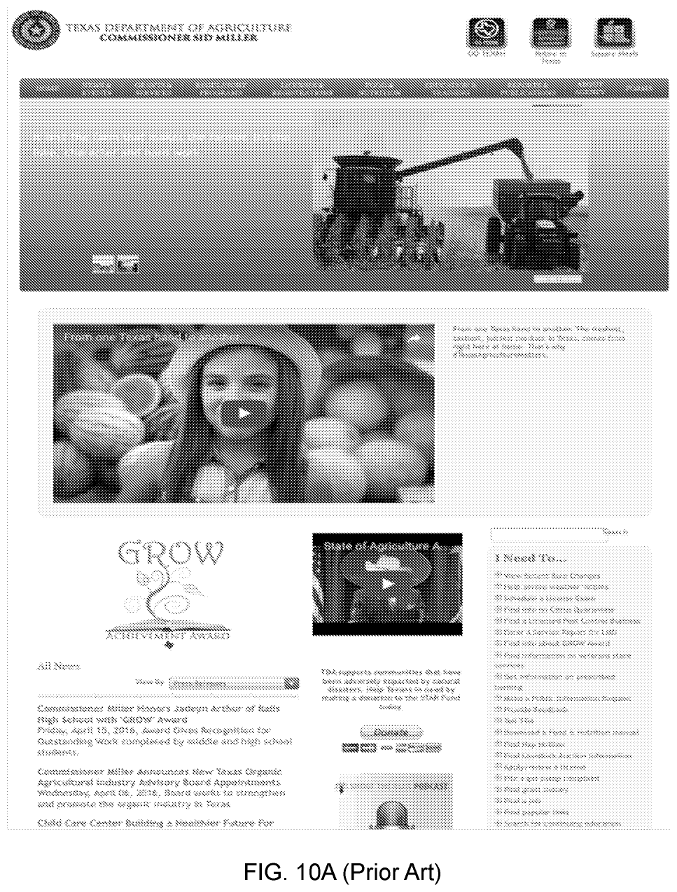

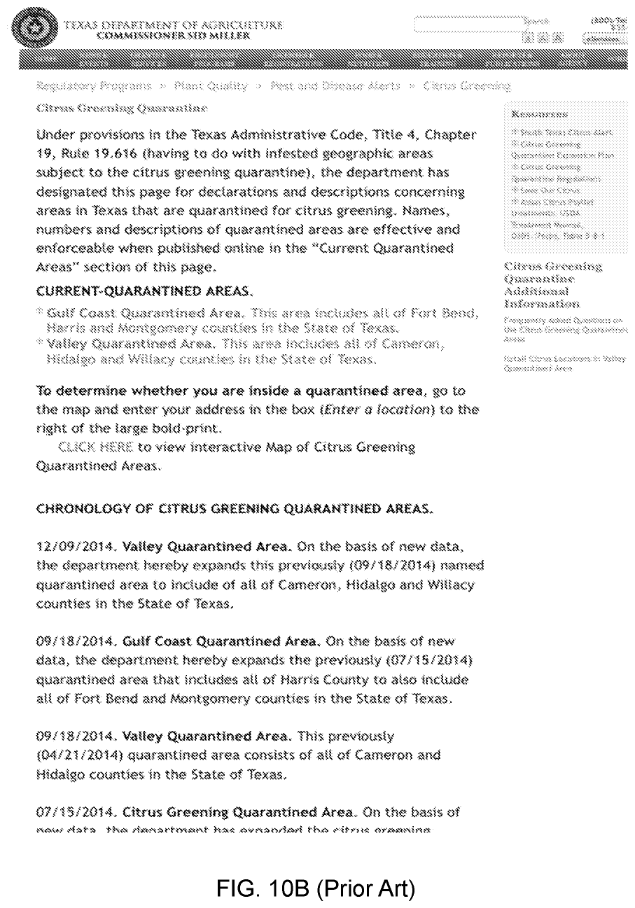

### DETAILED DESCRIPTION

Certain embodiments disclosed herein provide for systems, methods and apparatuses such as quarantine tags that are utilized with plant-specific and user-specific electronic information to aid in notification, tracking, education, enforcement and compliance with a plant quarantine zone and rules for a plant quarantine, and more specifically to quarantine tags with informational and computer-readable links for accessing plant-specific, location-specific and user-specific quarantine information via a mobile device, and for providing an application or browser-accessible quarantine information unique to a user, plant, location or other relevant parameters. For example, a quarantine tag may include text, symbols, images, colors, computer-readable codes and other information designed to help a user quickly and easily identify plant-specific and user-specific information related to a quarantine, including hyperlinks to electronic data accessible via a portable electronic device which provides and tracks location-specific, quarantine-specific and user-specific information to improve compliance and enforcement of the quarantine zone and prevent the spread of disease in cultivated plants. The user may be continuously provided with quarantine information on the portable electronic device through an application or browser which will continue to aid a user in complying with the quarantine after acquiring a specific plant.

After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

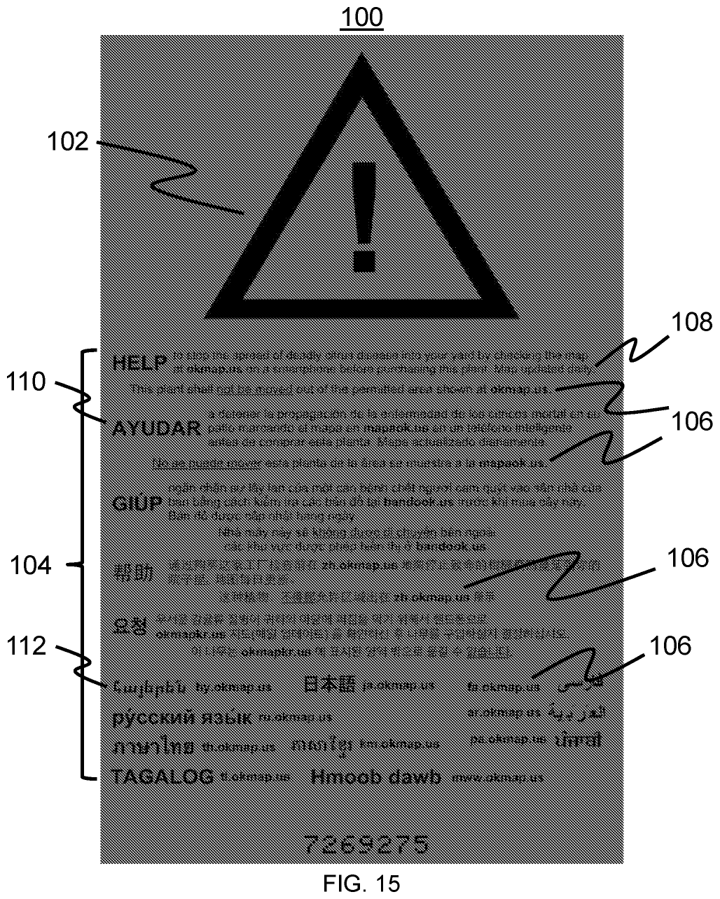

FIG. 15 is an illustration of an improved quarantine tag 100, according to one embodiment of the invention. The example improved quarantine tag 100 includes many features to make it perform better than the previous quarantine tags. Improved quarantine tags could incorporate any number of the new features of the example improved quarantine tag.

Included in the example improved quarantine tag 100 is a graphical element 102 included to capture the attention of a user, such as a person in a retail nursery considering the purchase of a citrus tree. The graphical element 102 of the example is an alert symbol, but it is imagined that there could be many graphical elements that could alternately be used. The graphical element 102 may also be helpful even in the case of illiterate customers. Rather than buying a tree and moving it without hesitation, the graphical element 102 may cause an illiterate customer to ask questions before purchasing the plant and create the opportunity for the illiterate customer to be educated as to where the plant may be moved. The tag 100 may also be provided in one or more colors, such as a bright red or yellow color, or a pattern such as a yellow and black striped pattern which would provide a universal indicator of a warning or caution.

The example improved quarantine tag 100 also includes multiple languages 104 on the same side of the tag. This avoids the situation where a speaker of a certain language misses the message because it is on the opposite side of the tag. It is imagined that a preferred improved quarantine tag would have duplicate information on the front and on the back; it would also be possible to have an improved quarantine tag with the languages all on only one side.

The example improved quarantine tag also includes hyperlinks 106 in multiple languages. The portion for each language preferably includes its own URL 106 different from the URLs used for other languages. By including different URLs for different languages it will be possible to direct speakers of different languages to language-appropriate web pages that will give information in the correct language and thus educate speakers of many languages as to where the plant may be moved.

The example improved quarantine tag includes URLs 106 that are much shorter than the URLs used on existing quarantine tags. The URLs also include only the domain portion and thus lack the “/” character. The URLs are thus much easier and quicker to enter on a touch-based virtual keyboard. This will make it more likely that a potential purchaser of a plant in a retail nursery will check the website and thus obey the quarantine.

Another improvement of the example improved quarantine tag is that the characters on the URL 106 are in bold and are thus more prominent. This makes it more likely that the URL will be noticed and entered on a smartphone and thus less likely that insects or disease will be spread.

A further improvement of the example improved quarantine tag is the “Map updated” wording 108. Although the frequency “daily” is used, it could also be less frequent such as “weekly”, “monthly”, or some other frequency. To the potential customer in the nursery it may not be clear that quarantined areas change over time. Without some sort of notification of this fact, the customer might be inclined to check the quarantine a first time, but fail to check the quarantine at some time in the future. Alternately, the notice that the quarantined areas are updated periodically could be included on the quarantine map website instead of on the quarantine tag. Whether or not the “Map updated” notice is included could also depend upon language and it could be included for only the most common language or languages.

Yet another improvement of the example improved quarantine tag is that the top five languages all have at least one key word 110 in much larger type that the rest of the wording in the language. This will help a person who speaks a certain language see more readily that the tag has information in the person's language. This is an advantage over the existing California ACP quarantine tag where it may not be obvious to a Spanish speaker who is looking from a distance that the tag contains Spanish wording. By having only a small portion of the wording in the larger type and the rest in smaller type, it will be possible to fit more on a quarantine tag and thus reach more people or reduce the cost of the quarantine tag by making a smaller quarantine tag possible than if all of the wording were in the larger type. This improvement will make it less likely that disease or insects will be spread.

The example improved quarantine tag 100 in FIG. 15 includes 15 languages. The first five languages, English, Spanish, Vietnamese, and Korean have larger numbers of people who speak them in California. The next ten languages, Armenian, Russian, Thai, Tagalog, Japanese, Khmer, Hmong, Farsi, Arabic, and Punjabi, have smaller numbers of speakers in California. For a quarantine to be most effective, people who speak any language should be able to learn about it easily. Because so many languages are used it would require a very large quarantine tag to include a full translation of the English language wording for each language; this could be costly and impractical. Instead, the ten languages with smaller numbers of speakers each have the name of the language in large type 112 and next to each language, a language-specific URL that leads to a web page for that language. This makes it possible to lead speakers of those languages to appropriate web pages with the use of little space on the quarantine tag. It is imagined that there could be many variations where speakers of less common languages could be addressed in a small amount of space on the tag. Another possible variation would be to include rather than the names of the languages, translations of the word “website” in the less common languages in large type next to the URLs.

It should be noted that some of the translations on the example improved quarantine tag for Spanish, Vietnamese, and Chinese were performed by computer software and that for best performance translations by humans need to be used instead.

Although the above quarantine tag was designed with California in mind, it should be noted that in different locations it will be desirable to choose the set of languages for the tag based upon the location. For example, in Spain the top three languages on a quarantine tag might be Spanish, Portuguese, and French; the languages could be selected based upon local census results.

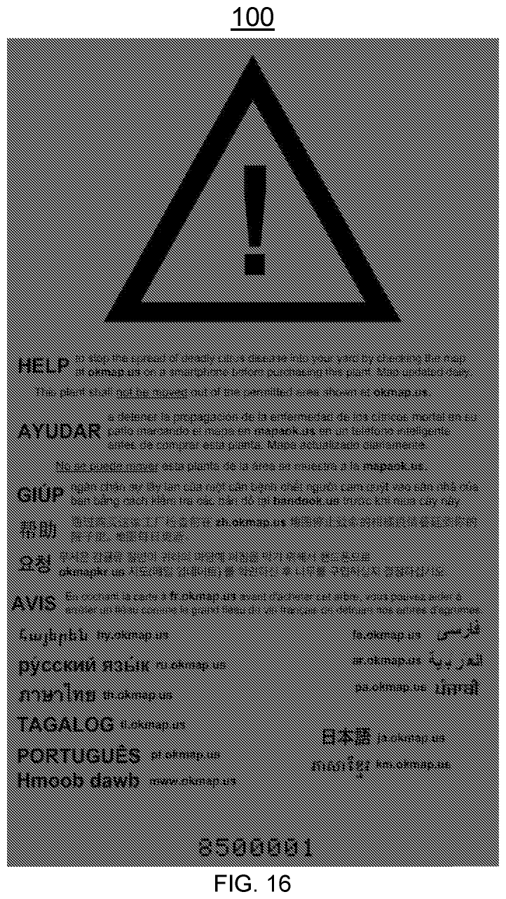

FIG. 16 shows a second example of an improved quarantine tag 100. The second example improved quarantine tag includes some further features in addition to those of the first example improved quarantine tag. The Vietnamese, Chinese, and Korean translations of “This plant shall not be moved out of the permitted area shown at okmap.us” have been removed. This creates free space on the quarantine tag that has been used to add two more languages, French and Portuguese. So the tag has the most information in the two most common languages, English and Spanish, less information for the next three most common languages, and even less information for the least common languages.

In internet marketing, it is known that the wording on a website or on an advertisement has a large impact on the number of people who respond to the web page or to the advertisement. Internet marketers commonly use split tests to determine the best wording. In a split test the response rate of different ways of wording are tested and compared; the best performing wording is then chosen. It is contemplated that a similar sort of test can be performed with the wording on quarantine tags since the tags lead to websites whose statistics can be gathered and compared. One way to perform such a test would be to use different URLs for different wording combinations and measure the number of visits to particular URLs. Another way to perform such a test would be to place tags with different wording (but the same URLs) in geographically separated locations and collect the geographic location of the website user using geolocation technology and compare the performance of the tags by comparing numbers of visits to particular URLs based upon location.

The current California quarantine tags have the exact English message translated into the Spanish equivalent message. It is contemplated that the best performing quarantine tag would not necessarily have the exact same message for the wording in each language. The message to persuade a person to perform a desired behavior often varies based upon the culture of the person being persuaded. Since language and culture go together, it is expected that different messages would work better for different languages. The English message for this second example quarantine tag includes “HELP to stop the spread of deadly citrus disease into your yard by checking the map at okmap.us on a smartphone before purchasing this plant. Map updated daily.” A French message is included that is quite different: “NOTICE: By checking the map at fr.okmap.us before purchasing this tree, you can help stop a blight like the great French wine blight from destroying our citrus trees.” The example French text was translated by a computer program; a human translated version would be superior. Because France experienced a similar problem with vineyards in the 19th century, it is contemplated that French speakers may better understand the problem as part of their culture and thus a different message may perform better with French speakers. This is just an example. The performance of different messages can be measured by testing and the best message for each language can be selected based upon the collected data. In the second example improved quarantine tag, different languages have different messages irrespective of translation. It is possible to create a further improved quarantine tag that includes the best-performing message in each language.

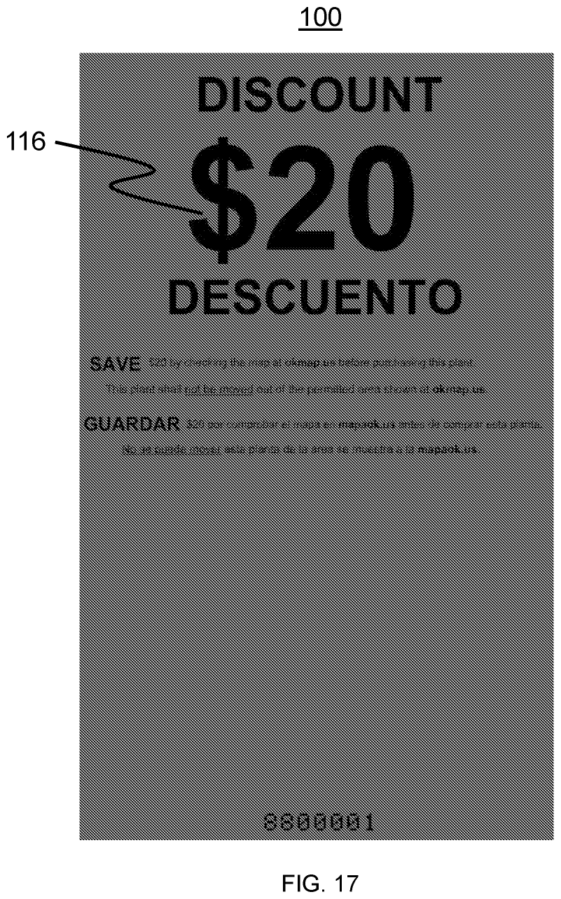

FIG. 17 shows a third example of an improved quarantine tag 100. The third example improved quarantine tag includes another method to persuade people to check the quarantine map. The tag includes as part of the message a benefit to the user of checking the quarantine map. As a benefit, the tag offers a discount 116 for checking the quarantine map. This could be either in the form of a coupon or of a rebate. A coupon could be offered on the mobile device in response to the user successfully checking the map. Alternately the user could be offered a rebate. One advantage of a rebate would be that the home address of the user could be collected via the website as part of the rebate process. The home address of the user could be useful in case disease were to be found at the nursery or in the surrounding neighborhood; if this were to happen, inspectors could be sent to addresses of people who bought trees and check the trees for disease.

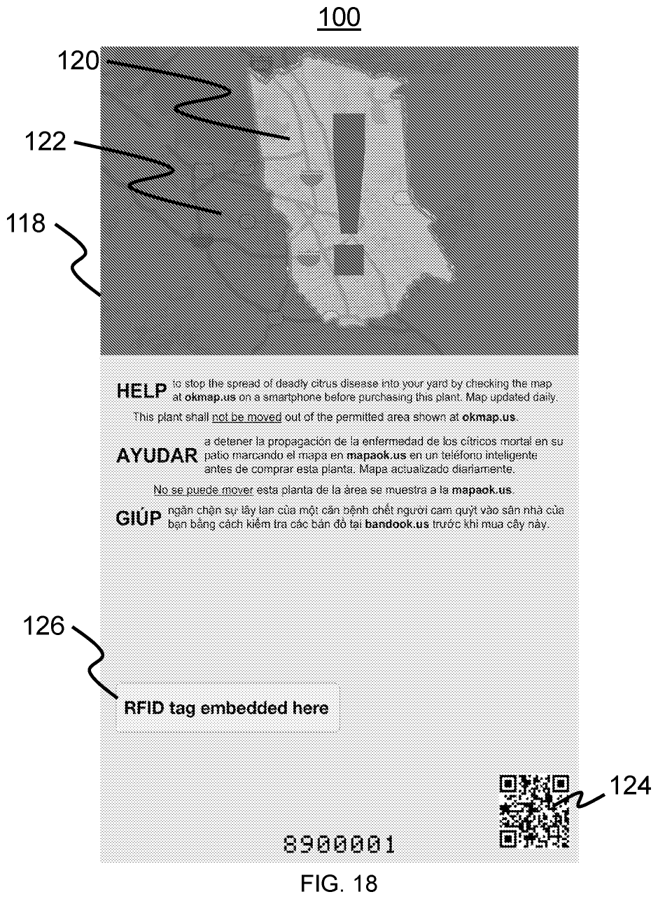

FIG. 18 shows a fourth example of an improved quarantine tag 100. The fourth example of an improved quarantine tag includes a different graphical element 118 included to capture the attention of people in the retail nursery considering the purchase of a citrus tree. The graphical element 118 is designed to look like a map of the quarantine zone, and although this particular example is based on a map of San Jose, Calif., it is imagined that a more generic map would be used that is not of a particular place. The graphical element 118 more particularly can include color shading to show the interior 120 of the quarantine zone in a first color with a positive connotation (such as green), while the area outside 122 the quarantine zone (where the user should not take the plant) is shaded in a color with a negative connotation or pattern (such as red).

The fourth example of an improved quarantine tag also includes a computer-readable graphical code 124 such as a QR code, NFC sensor, an embedded RFID tag 126 or other type of wireless sensor, code, symbol or other text which can be detected by a user's portable electronic device, either optically or wirelessly. Another possibility would be for a quarantine tag to include a QR code and not an RFID tag or to include an RFID tag and not a QR code. Either the QR code or the RFID tag could potentially allow a mobile computing device such as a smartphone to more easily and quickly show a quarantine map displaying the permitted movement of the plant. Both the RFID tag and the QR code could lead to either a downloadable application or a web page accessed through a browser application. The use of an electronic tag information will also allow the information to be continuously updated if the quarantine information changes, if the user changes the location of the plant, etc. such that the tag can continue to be useful and relevant after it has been created. This tag information may also be continuously updated at the user's mobile device, via an application on the mobile device, by having updates sent to the mobile device from a remote server, or via browser-accessible information available to the user via any browser application. In one embodiment, the mobile device may be configured to store individual plant information for the user that is tied into a user profile or account, so that the user or any government entity may have access to the plant information and location information corresponding to the plant. Through the use of a computer-readable code 124 or RFID sensor 126, a user or a government entity can periodically update the location of the plant by accessing the sensor in the tag via the application and ensure that the plant has not been moved out of a designated quarantine zone. It is also contemplated that the application may provide a notification tool for the user to notify a government authority or entity that a plant has contracted a disease in order to more easily report and update disease statistics and information. The notification may be a general notification or tied to a specific plant if a government authority is interested in tracking, testing and managing quarantine and disease statistics of specific plants over time.

For the case of the QR code or the RFID tag, the user's language for the map could be determined based upon the language configuration of the mobile computing device.

At the current state of technology standardization, web browsers are built into the most common mobile computing devices such as smartphones or tables. RFID readers and QR code software are less universal. So at the moment it is contemplated that a quarantine tag that uses URLs will be preferred, but in the future an implementation that uses RFID readers, QR code scanning, or another technology that avoids the need for the user to type in a URL may be preferred if these technologies are standardized and widely adopted.

The following examples are shown using a mobile web browser. It is contemplated that the examples could also be implemented using an application on a mobile communication device without the use of a mobile web browser.

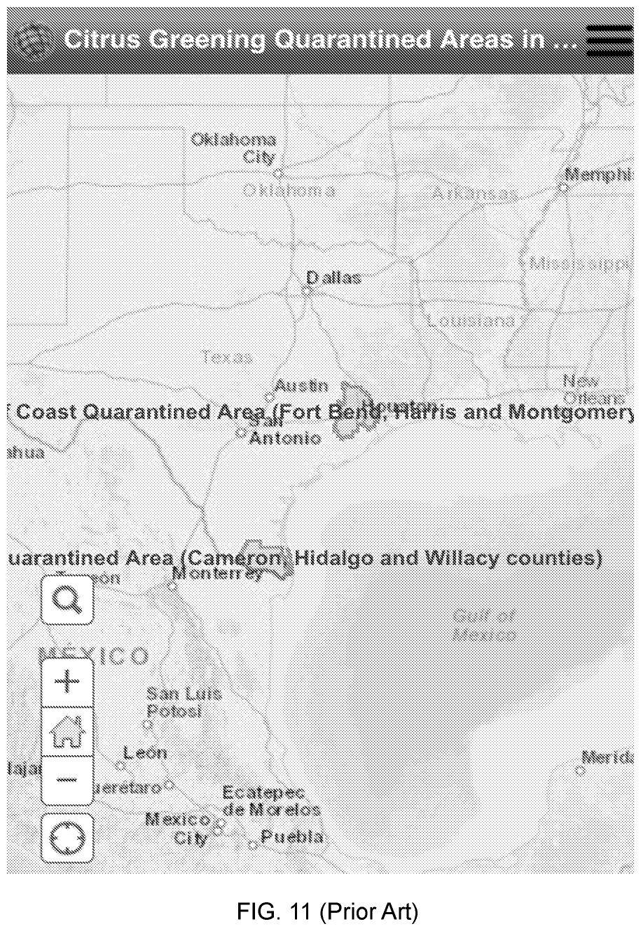

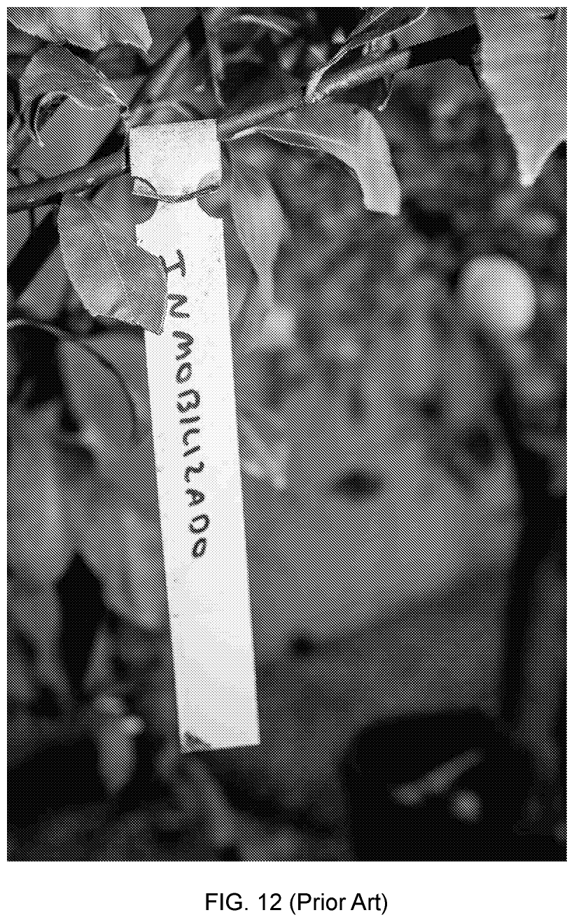

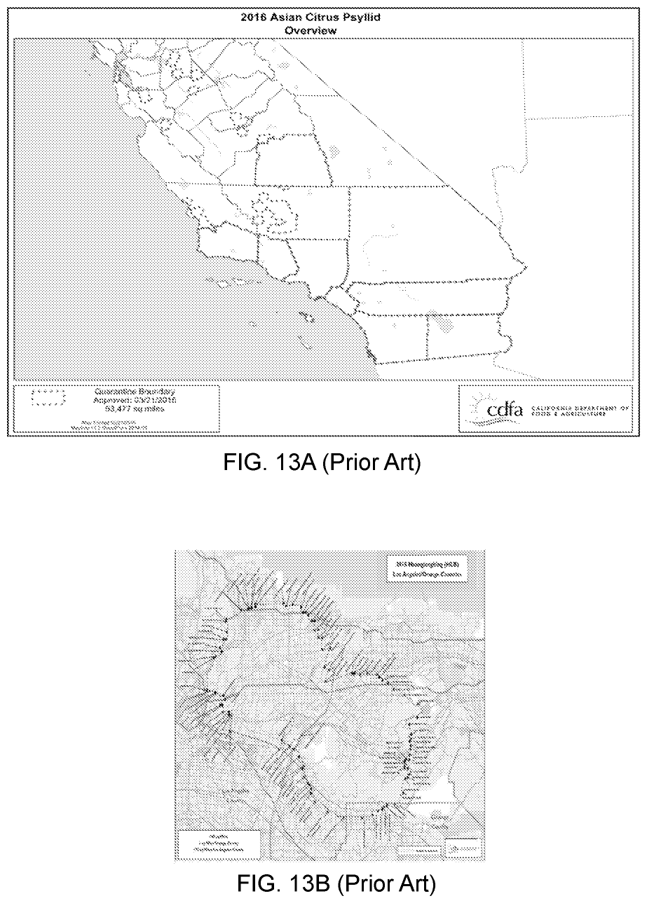

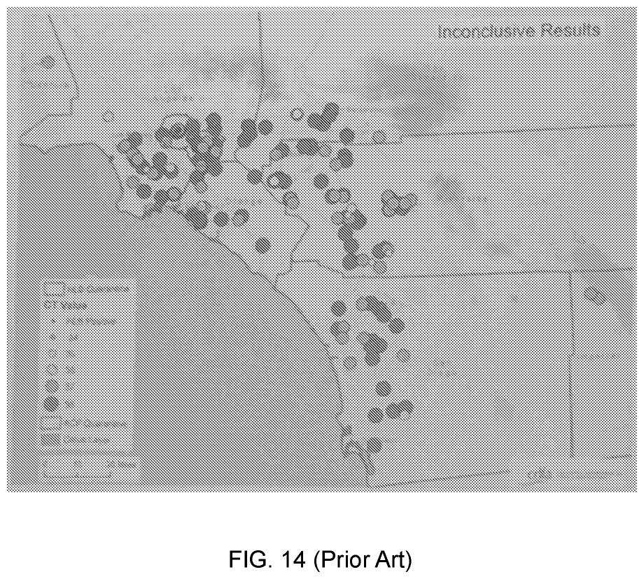

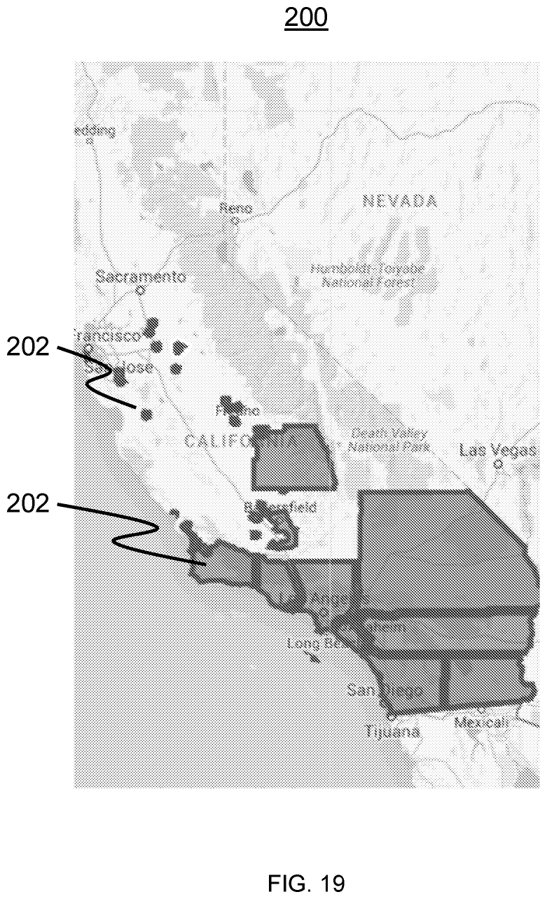

A quarantine map 200 in FIG. 19 shows what a view of the California ACP quarantine areas 202 might look like if viewed on a map in a web browser, according to known embodiments. With so many quarantine areas 202 this would be confusing to many users in the same way that the current Texas HLB quarantine map view in FIG. 11 is. Furthermore, showing the extent of the infestation throughout the state to a person considering the purchase of a tree in a nursery could have a negative impact on the person's likelihood of complying with the quarantine. Considering human psychology, a person seeing such an infestation might think that the insects and/or disease are going to spread regardless of an individual's behavior; if the person decides to violate the quarantine based upon such an assessment then insects and disease are more likely to spread. So in fact, presenting the person in the nursery with the full extent of the quarantined area may be detrimental to compliance with the quarantine.

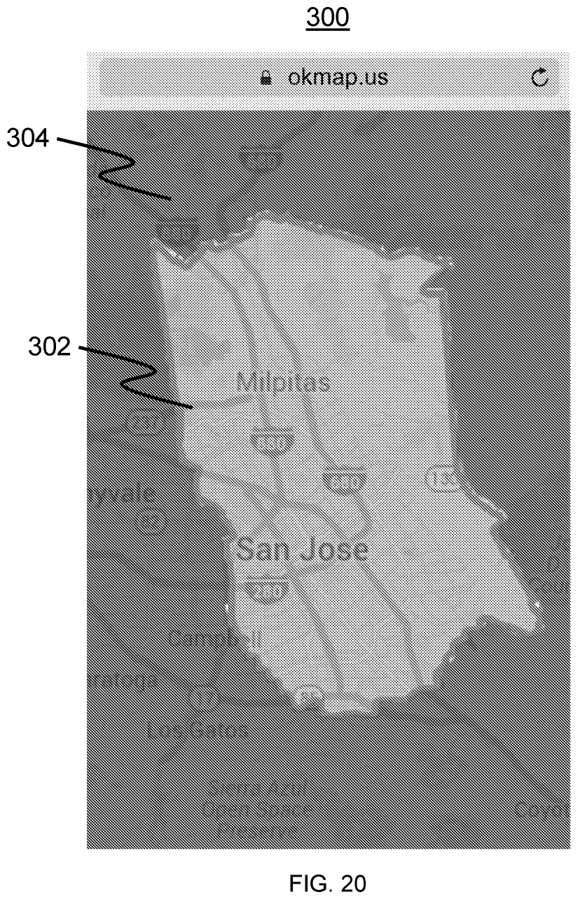

FIG. 20 shows an improved quarantine map 300 to show a person very clearly where a citrus tree can be moved. Suppose a person is considering buying a citrus tree in San Jose, Calif. in a nursery in the area 302 quarantined for ACP. After the person reads the quarantine tag and goes to okmap.us, the website will acquire the location of the user via geolocation technology on the smartphone. The website will then display an appropriate map 300 for the location showing the quarantine zone area 302 that clearly illustrates where the tree can and cannot be moved. One way to show this clearly would be via colors on the map; for example, green for the inside 302 of the quarantine zone where movement is allowed, and red for outside 304 of the quarantine zone where movement is not allowed. As shown in the above example, color can be combined with the map with an opacity that still allows the elements of the map such as roads and other features to be seen clearly. There are other ways that the geographic area where the tree is allowed to be moved could be shown clearly; for example, the allowed area could be distinguished via different shading, texture, etc. compared to the area where the tree is not allowed to be moved. In one embodiment, the map may be interactive and provide an indicator of the user's current location within the map, even providing continuous updates as the user travels to different locations such that the user may receive a notification if they are nearing the border or have crossed outside of the quarantine zone.

One significant improvement over the previous websites is that the user goes directly to the desired map page after entering the URL and there are no intermediate pages where the user must find and choose the correct link to get to the map information.

It is also imagined that there could be text on the screen to explain to the user the meaning of the color-coding. In addition, the web page could play an audible message in the appropriate language to the user regarding the quarantine situation.

For the case of the proposed California multizone statewide ACP quarantine scheme, this method of displaying where a tree can be moved would be far superior to the previous methods which would simply show the entire state as an ACP quarantined area. If this method were to be used with the proposed California multizone statewide ACP quarantine scheme, the zone that the user is in could be shown using Green and the rest of the state could be shown using Red.

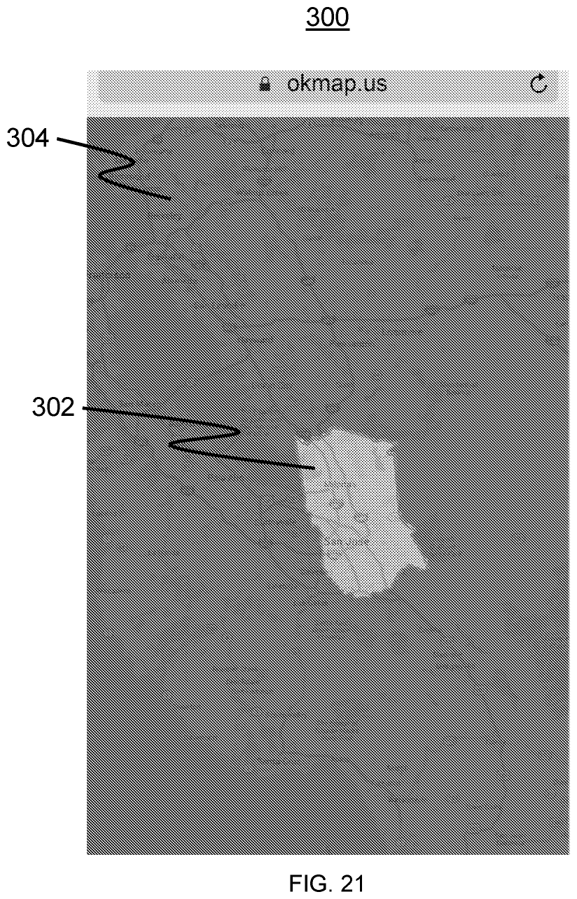

FIG. 21 shows a zoomed-out view of the quarantine map 300 shown in FIG. 20. It should be noted that other ACP quarantined areas exist in this zoomed out view, but they are irrelevant to the person in San Jose since San Jose plants should not be moved to the other ACP quarantined areas. The other ACP quarantined areas are shown as red, the same color as any other area where the plants should not be moved.

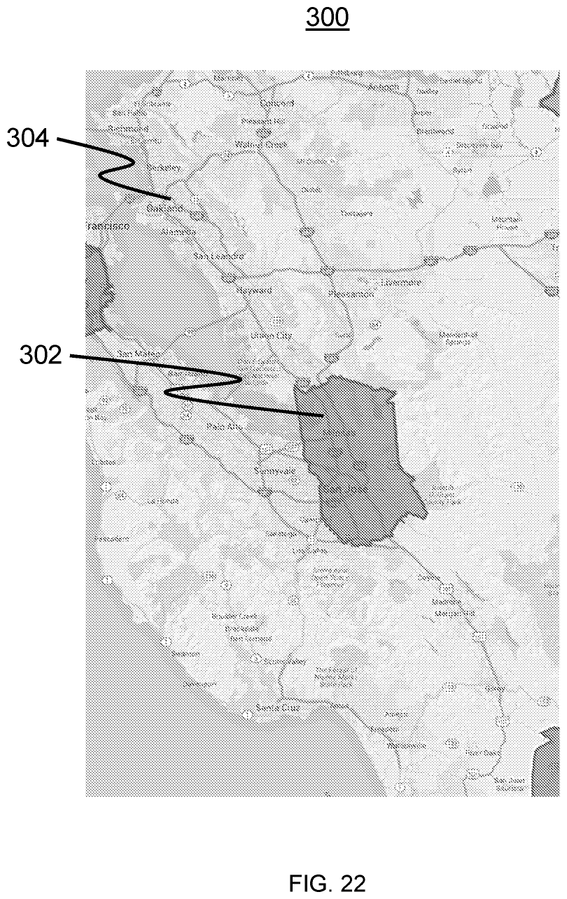

FIG. 22 shows how the quarantine map in FIG. 21 would look if a method like that currently used in Texas were used instead of the improved method. The multiple quarantine areas 302 on the map 300 are less clear, as are the non-quarantine areas 304, which could cause confusion to a user and could even make the user more likely to violate the quarantine.

Yet another potential improvement would be for the web page or application to indicate to the user that the plant is not to be moved at all if geolocation shows that the user is not at a known nursery. Furthermore, it should be noted that illegal nurseries could exist that are unknown to the regulating authorities. Such illegal nurseries come with extreme risk as to the spread of insects and diseases. In addition to telling the user that the plant is not to be moved, the system could send a message to the regulating authorities (such as the CDFA) including the determined location. If a number of such messages were received by the regulating authorities with the same location, inspectors could be sent to the location to see if an illegal nursery is present.

Another potential improvement would be to ask for the user's address (i.e. the intended destination of the plant) and check if it is OK to move the plant to the address. If the address is outside of the permitted area of movement, then the user could be informed of that. For example, the user could scan the QR or RFID on the tag and the mobile application would immediately compare the user's stored home address with the quarantine information embedded in the tag to determine if the user can purchase the plant. Furthermore, if the user's address is outside of the permitted area of movement, then suggestions of alternate nurseries could be made from which movement would be permitted to the user's address. The suggestion could include all possible nurseries or it could be a limited list of one or more nurseries that are affiliated with the nursery at the user's current location. In addition (or alternately), the user could be given recommendations of one or more mail order nurseries that give the ability to order a plant online. The recommendation could be in the form of a clickable link. The advantage of the online nurseries is that the user would have a greater choice of trees and the tree would be shipped directly to the user's address from a disease-free and insect-free source in a sealed container. Use of such an online nursery would preclude the spread of insects or disease. A list of recommended alternate nurseries could potentially be determined based upon the user's location. So each nursery could have its own list of alternates and the alternates could be determined based upon location.

Yet another potential improvement to the method of checking a user's address would be to check the fastest or shortest route to the address and see if the route crossed a quarantine boundary. If the user's address is permissible for movement of the plant, but the route crosses a quarantine boundary, then an alternate route that does not cross the quarantine boundary can be recommended to the user. Another option would be to alert the user via a real-time notification on the user's portable electronic device if they have moved out of the quarantine zone and when they move back into the quarantine zone using location-based services on the portable electronic device. The location-based services and notifications could also be implemented into a computing device in the user's vehicle if the vehicle is used to transport plants.

Yet another improvement would be to give the user extra education via at least one of audio, video, imagery, and hyperlinks on the mobile communications device in addition to the map. The extra education could be on the topic of disease or insects, for example, and may vary depending on the user's geographic location, climate, etc. For example, due to climate differences or the presence of certain insects (such as ants) in different geographic areas, the extra educational material could vary. A specific example would be to give a user in California extra information about Argentine Ants, while a user in Texas might be given extra information about fire ants.

One further improvement to a website that displays quarantine information to a user would be to enable the website for remarketing technology. Remarketing technology allows information such as advertisements to be delivered in the future to a visitor of a particular website or a user of an application. Additions to a web page to enable remarketing typically involve adding tracking code to the code of the web page. The tracking code could be for example a Facebook® pixel, tracking code from Google®, tracking code from another search engine such as Bing®, tracking code from Twitter®, a cookie, or other tracking code. The tracking code allows the user's visit to the web page to be tracked by these other entities. For the case of an application displaying quarantine information, a tracking code can also be added. The user's attention in the nursery will be focused on shopping, and the user may not have time to be fully educated about quarantines, insects, diseases, etc. even if all of this information were available on the web page or web site. Based upon the user's visit to the web page or use of an application displaying quarantine information, these entities can be used to deliver advertisements to the user in the future. Advertisements could be, for example, videos played before YouTube® videos, thumbnails on YouTube® that lead to other videos, videos or other types of ads in a user's Facebook® feed, ads on Twitter®, or ads on any other website or in any application on the user's portable electronic device. In the past efforts have been made to reach people via 20 th century technologies such as radio, television, and newspapers to educate them regarding citrus insects and disease and how to avoid and stop their spread; due to the nature and expense of these technologies and due to the decline of these technologies it has been difficult to reach people. The people who most need to be reached are those who are interested in the particular type of plant that has the quarantine tag at the nursery. So the use of remarketing technology in response to a user's interaction with a quarantine tag is a significant improvement in the ability to teach people how to avoid and stop the spread of insects and diseases. Advertisements can be delivered to teach the user in great detail how to avoid the spread of insects and diseases.

Yet a further improvement that is contemplated in conjunction with the preceding improvements is a method to help with the reporting of insects in a nursery. After the user has finished looking at the map, the web page or mobile application can ask the user for help spotting insects. As previously mentioned, insects in a nursery such as Asian citrus psyllids carry a high risk for the spread of disease. It is expensive to hire inspectors to visit nurseries and inspect for insects. The web page or mobile application could inform the user of an insect of interest such as the Asian citrus psyllid and present photos or video of what to look for. The user could be asked if the insect is seen and if so, to submit a photo. The photo and information would then be forwarded to the interested parties such as the CDFA or the USDA. Combining this functionality with the quarantine map functionality produces a great improvement since the user is already in the nursery and in a position to help inexpensively. The spread of insects and disease can thus be reduced as the proper authorities would be informed of the problem where it was previously too expensive.

### New Quarantine Method Using HLB Risk

The new methods to show a person in a nursery where a tree can be moved via a smartphone would enable a new and improved method of quarantining areas.

Currently all of Southern California is quarantined for the ACP. The HLB quarantine exists in Los Angeles. Currently a person could buy a tree at a nursery near the HLB quarantine area and move it anywhere in Southern California. A tree at such a location would be at a significantly higher risk for HLB than trees further from the HLB quarantine area. Likewise a person could buy a tree at a nursery near a cluster of locations from which tested samples had inconclusive Ct values and move the tree anywhere in Southern California. Both of these risk the long distance movement of HLB.

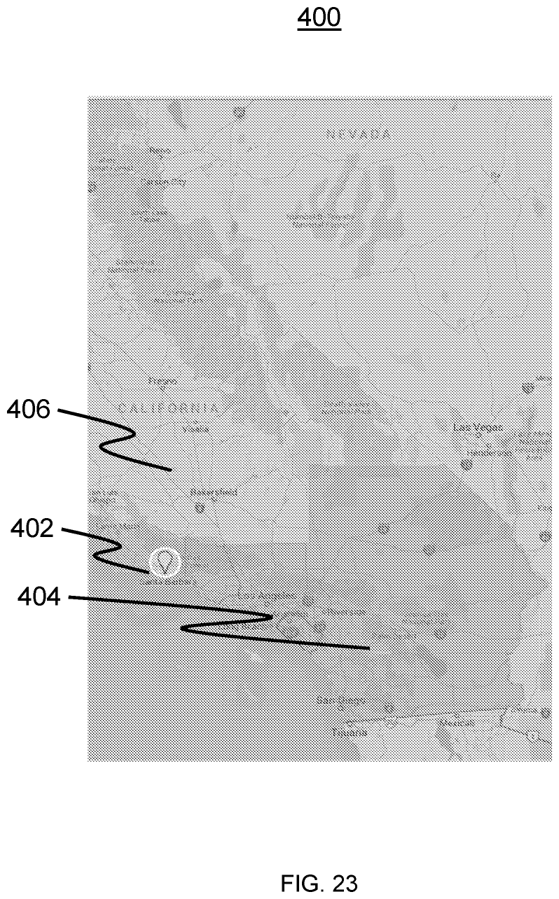

An improved quarantine scheme could take into account HLB risk variables for the locations of each nursery. The degree to which movement of a tree is restricted could be based upon HLB risk at a particular location. For example, the movement from a nursery near the HLB quarantine area or near a cluster of locations from which tested samples had Ct values in a certain range (i.e. inconclusive by the current testing standard) could be restricted to a very short distance. The movement from a nursery that is at low risk for HLB could be less restricted. FIG. 23 shows an example of this quarantine risk map 400. Suppose a user 402 at a nursery in Santa Barbara (shown by the marker 402 ) were to use a smartphone to check the area 404 where a citrus tree is allowed to be moved. In Santa Barbara, the Asian citrus psyllid has not been present as long as in areas further to the south. There are no HLB detections near Santa Barbara and there are no clusters of locations from which tested samples had inconclusive Ct values. So the tree in the nursery in Santa Barbara is at a lower risk for HLB. In this case the tree is allowed to be moved anywhere in the contiguous area quarantined for Asian citrus psyllids in southern California, but not in the area 406 outside of the contiguous quarantine area 404.

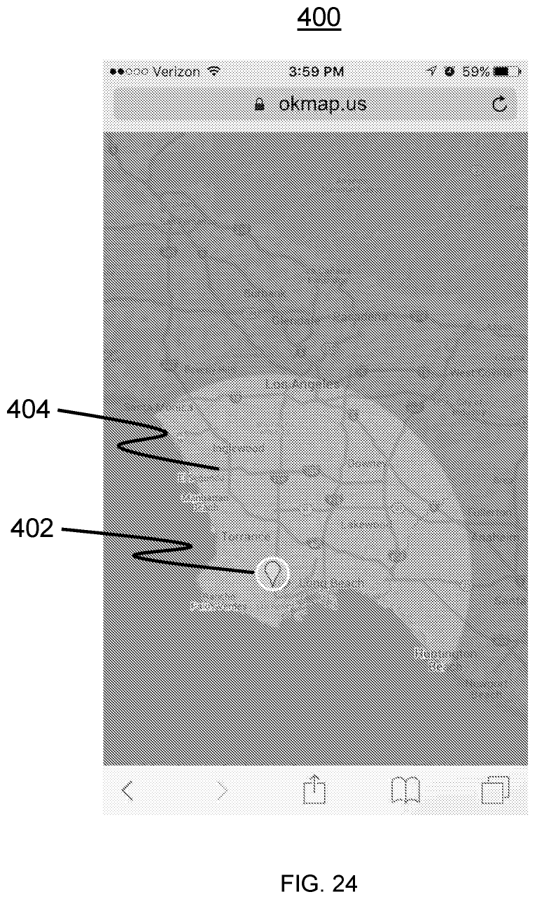

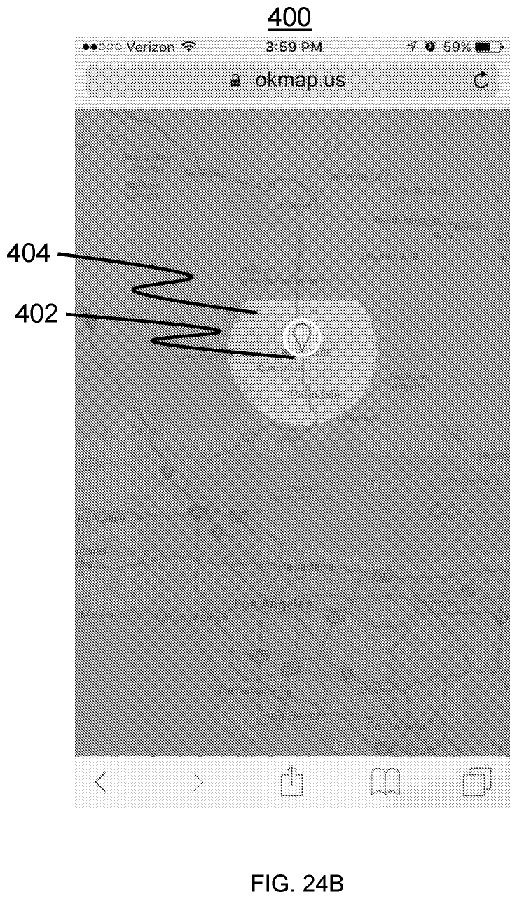

Each nursery location could have a different area 404 of permitted movement. This could be updated over time as the calculated HLB risk for the location changes. One example illustrated in the map 400 in FIG. 24 would be to calculate a circular area 404 of permitted movement centered at the nursery and with a radius that varies according to risk of HLB. Alternately the radius could be used with a fixed value if the risk of HLB exceeded a threshold for a particular location. Suppose a user at a nursery in Long Beach (shown by the marker 402) were to use a smartphone to check the area where movement of a citrus tree is allowed. In Long Beach, there are nearby clusters of locations from which tested samples had inconclusive Ct values. So the calculated risk of HLB at the Long Beach nursery is higher. So the nursery in Long Beach has a smaller area of permitted movement within the contiguous area quarantined for Asian citrus psyllids in southern California.

As another example, consider the town of Lancaster, California, which is near the northern border of the contiguous portion of southern California currently quarantined for the Asian citrus psyllid. No plant or tissue samples have tested positive for HLB or inconclusive for HLB in Lancaster, so currently plants sold at a nursery in Lancaster could be moved anywhere in the contiguous area quarantined for ACP as in the above example of the nursery from Santa Barbara. Suppose, for example, a closely-grouped cluster of locations in Lancaster had samples tested for HLB and the Ct values were in the inconclusive range. As illustrated in FIG. 24B, a circular area 404 of permitted movement could be created around a nursery 402 in Lancaster based upon the HLB risk. Since the circle 404 goes outside of the ACP quarantined area, the two would be combined using the intersection of the areas. The intersection shows the area of permitted movement.

Furthermore, this could be combined with a multizone statewide quarantine scheme; the more restrictive of the boundary for the nursery and the statewide multizone boundary could be used when drawing maps showing where movement is permitted.

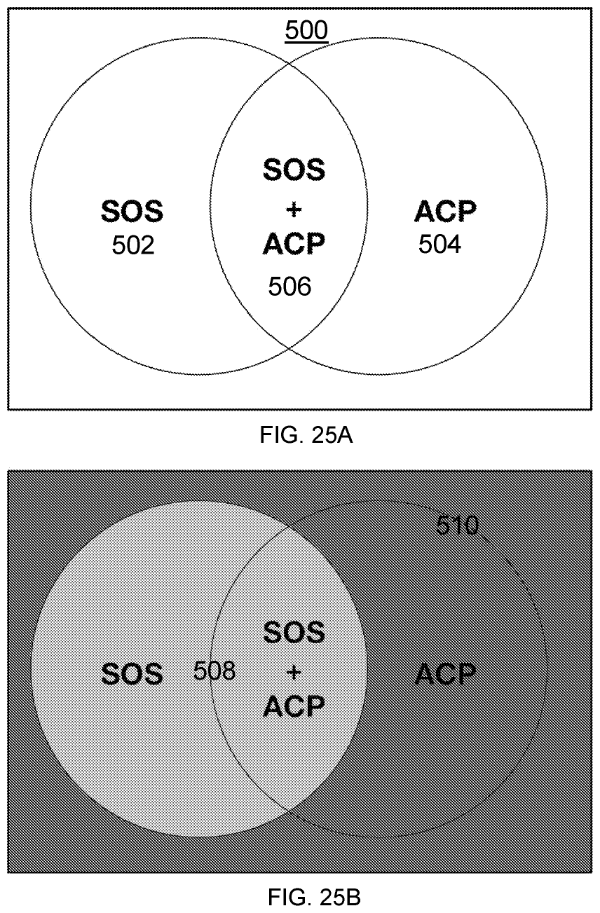

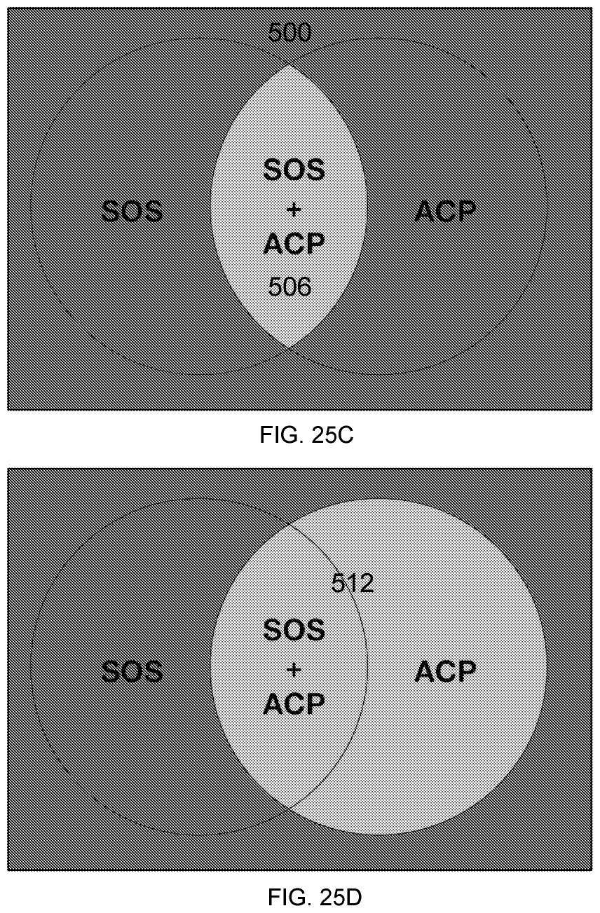

FIG. 25A shows an example of overlapping quarantined areas 500 when multiple quarantine conditions are present in a geographic area. The first circular area 502 on the left has been quarantined for Sweet Orange Scab. The second circular area 504 on the right has been quarantined for Asian citrus psyllids. The center area 506 where the two circles are intersecting has been quarantined for both Sweet Orange Scab and Asian citrus psyllids. The nonoverlapping portion of the circular area 502 on the left has been quarantined for Sweet Orange Scab only. The nonoverlapping portion of the circular area 504 on the right has been quarantined for Asian citrus psyllids only.

FIG. 25B shows an example of a map that could be displayed to customers of nurseries in the nonoverlapping portion of the circular area on the left that has been quarantined for Sweet Orange Scab only. Plants originating in those nurseries would be allowed to be moved anywhere in the green-colored circular area 508, but not in the area 510 outside the circle 508. FIG. 25C shows an example of a map 500 that could be displayed to customers of nurseries in the area where the two circles are intersecting 506 that has been quarantined for both Sweet Orange Scab and Asian citrus psyllids. Plants originating in those nurseries would be allowed to be moved anywhere in the green-colored area 506. FIG. 25D shows an example of a map that could be displayed to customers of nurseries in the nonoverlapping portion 512 of the circular area on the right that has been quarantined for Asian citrus psyllids only. Plants originating in those nurseries would be allowed to be moved anywhere in the green-colored circular area 512.

Although the preceding example used quarantines for Sweet Orange Scab and Asian citrus psyllid to demonstrate how the invention can be used to clearly demonstrate to a purchaser of a plant where the plant can be moved, it should be noted that the invention could be used in conjunction with any type of disease or pest (such as insect) quarantine. The invention is not limited to citrus trees and would be useful for any type of disease or insect pest.

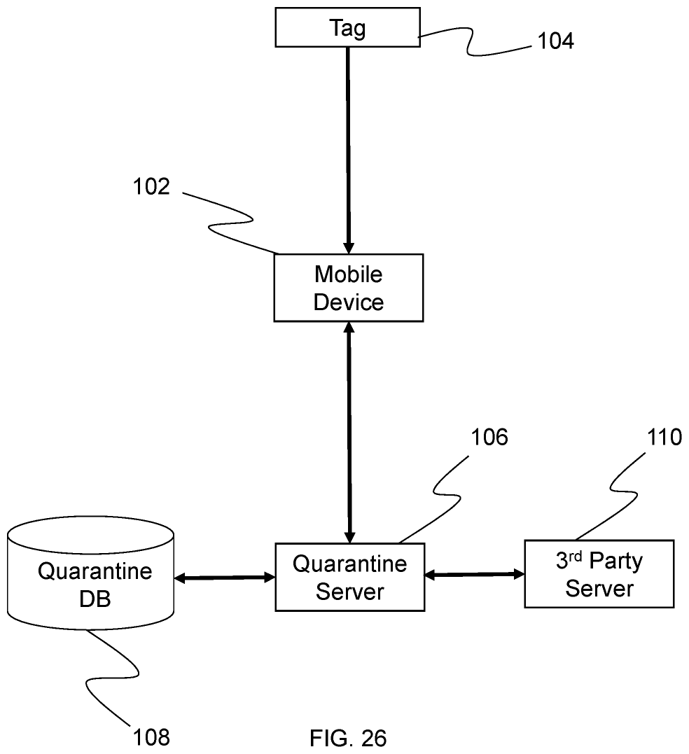

FIG. 26 illustrates one embodiment of a system for providing user-specific plant quarantine information, where a user with a mobile device 102 can read a tag 104 with at least one informational link that instructs the mobile device to access quarantine information from a quarantine server 106 in a remote location. As has been described above, the tag 104 may have a barcode, QR code, RFID, NFC, URL or other computer-readable code or symbol which can be interpreted by the mobile device 102 in order to obtain pertinent information on a plant quarantine. The quarantine server 106 may store quarantine information relevant to a quarantined plant and relevant to the user's location in a Quarantine Database 108 or as received from a Third Party Server 110 such as a government database. User-specific information and location-specific information may be obtained from the mobile device 102, which may be any type of portable electronic device such as a smartphone, tablet, etc. which is able to use sensors to automatically determine location information and store user profile information. Alternatively, the user-specific and location-specific information may be entered manually by the user and pre-stored remotely at the Quarantine Server 106 and corresponding Quarantine Database 108. The quarantine information may be displayed on the mobile device 102 via a browser application or mapping application on the mobile device or via a use-specific quarantine application on the mobile device.

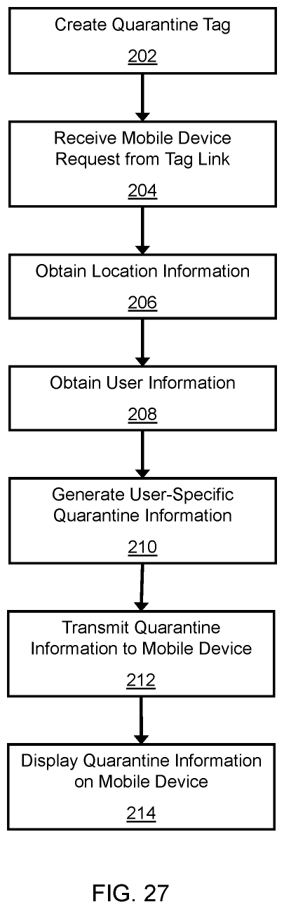

FIG. 27 illustrates on embodiment of a method of providing a quarantine tag and quarantine information to a user, wherein in a first step 202, a quarantine tag is created with relevant quarantine information printed or electronically imprinted therein. Next, in step 204, a user with a mobile device utilizes a link on the quarantine tag—such as a scan of a QR code, direct entry of a browser address, etc.—to request additional quarantine information from a remote quarantine server. In steps 206 and 208, the server may receive location information from the mobile device and user-specific information related to the user that will aid in step 210, of generating unique, relevant user-specific quarantine information. The quarantine information is then transmitted to the mobile device in step 212, after which the information is displayed to the user in step 214.

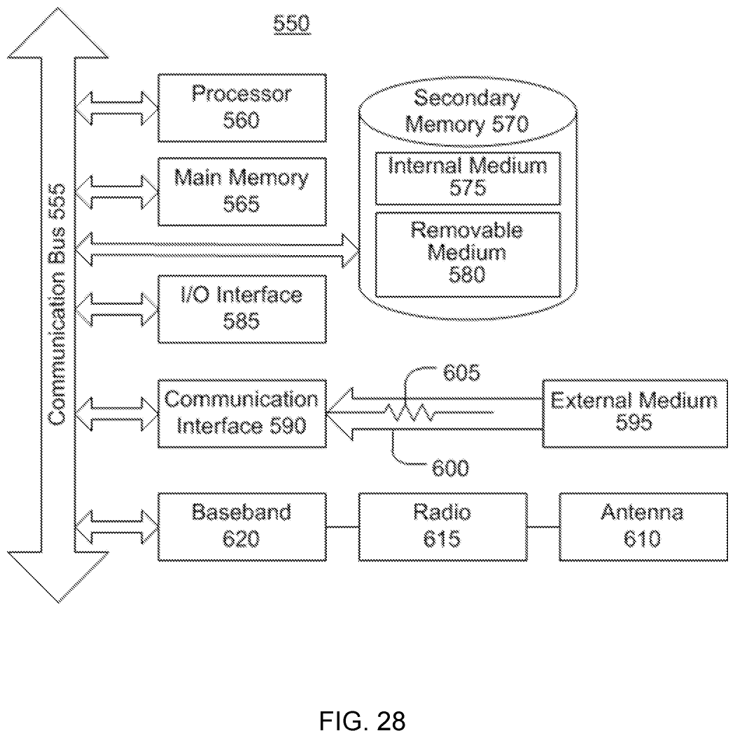

FIG. 28 is a block diagram illustrating an example wired or wireless system 550 that may be used in connection with various embodiments described herein. For example the system 550 may be used as or in conjunction with a system for providing quarantine information as previously described with respect to FIGS. 15-27. The system 550 can be a conventional personal computer, computer server, personal digital assistant, smart phone, tablet computer, or any other processor enabled device that is capable of wired or wireless data communication. Other computer systems and/or architectures may be also used, as will be clear to those skilled in the art.

The system 550 preferably includes one or more processors, such as processor 560. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 560.

The processor 560 is preferably connected to a communication bus 555. The communication bus 555 may include a data channel for facilitating information transfer between storage and other peripheral components of the system 550. The communication bus 555 further may provide a set of signals used for communication with the processor 560, including a data bus, address bus, and control bus (not shown). The communication bus 555 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

System 550 preferably includes a main memory 565 and may also include a secondary memory 570. The main memory 565 provides storage of instructions and data for programs executing on the processor 560. The main memory 565 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 570 may optionally include a internal memory 575 and/or a removable medium 580, for example a floppy disk drive, a magnetic tape drive, a compact disc (“CD”) drive, a digital versatile disc (“DVD”) drive, etc. The removable medium 580 is read from and/or written to in a well-known manner. Removable storage medium 580 may be, for example, a floppy disk, magnetic tape, CD, DVD, SD card, etc.

The removable storage medium 580 is a non-transitory computer readable medium having stored thereon computer executable code (i.e., software) and/or data. The computer software or data stored on the removable storage medium 580 is read into the system 550 for execution by the processor 560.

In alternative embodiments, secondary memory 570 may include other similar means for allowing computer programs or other data or instructions to be loaded into the system 550. Such means may include, for example, an external storage medium 595 and an interface 570. Examples of external storage medium 595 may include an external hard disk drive or an external optical drive, or and external magneto-optical drive.

Other examples of secondary memory 570 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage media 580 and communication interface 590, which allow software and data to be transferred from an external medium 595 to the system 550.

System 550 may also include an input/output (“I/O”) interface 585. The I/O interface 585 facilitates input from and output to external devices. For example the I/O interface 585 may receive input from a keyboard or mouse and may provide output to a display. The I/O interface 585 is capable of facilitating input from and output to various alternative types of human interface and machine interface devices alike.

System 550 may also include a communication interface 590. The communication interface 590 allows software and data to be transferred between system 550 and external devices (e.g. printers), networks, or information sources. For example, computer software or executable code may be transferred to system 550 from a network server via communication interface 590. Examples of communication interface 590 include a modem, a network interface card (“NIC”), a wireless data card, a communications port, a PCMCIA slot and card, an infrared interface, and an IEEE 1394 fire-wire, just to name a few.

Communication interface 590 preferably implements industry promulgated protocol standards, such as Ethernet IEEE 802 standards, Fiber Channel, digital subscriber line (“DSO, asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 590 are generally in the form of electrical communication signals 605. These signals 605 are preferably provided to communication interface 590 via a communication channel 600. In one embodiment, the communication channel 600 may be a wired or wireless network, or any variety of other communication links. Communication channel 600 carries signals 605 and can be implemented using a variety of wired or wireless communication means including wire or cable, fiber optics, conventional phone line, cellular phone link, wireless data communication link, radio frequency (“RF”) link, or infrared link, just to name a few.

Computer executable code (i.e., computer programs or software) is stored in the main memory 565 and/or the secondary memory 570. Computer programs can also be received via communication interface 590 and stored in the main memory 565 and/or the secondary memory 570. Such computer programs, when executed, enable the system 550 to perform the various functions of the present invention as previously described.

In this description, the term “computer readable medium” is used to refer to any non-transitory computer readable storage media used to provide computer executable code (e.g., software and computer programs) to the system 550. Examples of these media include main memory 565, secondary memory 570 (including internal memory 575, removable medium 580, and external storage medium 595), and any peripheral device communicatively coupled with communication interface 590 (including a network information server or other network device). These non-transitory computer readable mediums are means for providing executable code, programming instructions, and software to the system 550.

In an embodiment that is implemented using software, the software may be stored on a computer readable medium and loaded into the system 550 by way of removable medium 580, I/O interface 585, or communication interface 590. In such an embodiment, the software is loaded into the system 550 in the form of electrical communication signals 605. The software, when executed by the processor 560, preferably causes the processor 560 to perform the inventive features and functions previously described herein.

The system 550 also includes optional wireless communication components that facilitate wireless communication over a voice and over a data network. The wireless communication components comprise an antenna system 610, a radio system 615 and a baseband system 620. In the system 550, radio frequency (“RF”) signals are transmitted and received over the air by the antenna system 610 under the management of the radio system 615.

In one embodiment, the antenna system 610 may comprise one or more antennae and one or more multiplexors (not shown) that perform a switching function to provide the antenna system 610 with transmit and receive signal paths. In the receive path, received RF signals can be coupled from a multiplexor to a low noise amplifier (not shown) that amplifies the received RF signal and sends the amplified signal to the radio system 615.

In alternative embodiments, the radio system 615 may comprise one or more radios that are configured to communicate over various frequencies. In one embodiment, the radio system 615 may combine a demodulator (not shown) and modulator (not shown) in one integrated circuit (“IC”). The demodulator and modulator can also be separate components. In the incoming path, the demodulator strips away the RF carrier signal leaving a baseband receive audio signal, which is sent from the radio system 615 to the baseband system 620.

If the received signal contains audio information, then baseband system 620 decodes the signal and converts it to an analog signal. Then the signal is amplified and sent to a speaker. The baseband system 620 also receives analog audio signals from a microphone. These analog audio signals are converted to digital signals and encoded by the baseband system 620. The baseband system 620 also codes the digital signals for transmission and generates a baseband transmit audio signal that is routed to the modulator portion of the radio system 615. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 610 where the signal is switched to the antenna port for transmission.

The baseband system 620 is also communicatively coupled with the processor 560. The central processing unit 560 has access to data storage areas 565 and 570. The central processing unit 560 is preferably configured to execute instructions (i.e., computer programs or software) that can be stored in the memory 565 or the secondary memory 570. Computer programs can also be received from the baseband processor 610 and stored in the data storage area 565 or in secondary memory 570, or executed upon receipt. Such computer programs, when executed, enable the system 550 to perform the various functions of the present invention as previously described. For example, data storage areas 565 may include various software modules (not shown) that are executable by processor 560.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

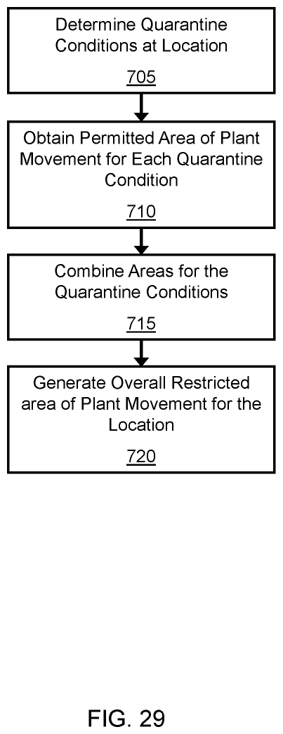

FIG. 29 shows an example of a method that could be used as part of step 210 of FIG. 27 to generate quarantine information. This method could be used when there are locations with multiple quarantine conditions as described with respect to FIG. 25A, FIG. 25B, FIG. 25C, and FIG. 25D, for example. This method could be performed in response to a user requesting quarantine information; alternatively, this method could be performed ahead of time and the results for particular locations could be stored for later use. At step 705 the method determines quarantine conditions at a location. At step 710 the method obtains the permitted area of plant movement for each quarantine condition. Continuing to step 715, the method combines the areas for the quarantine conditions; this could be an intersection of the areas, for example. At step 720 an overall restricted area of plant movement for the location is generated.

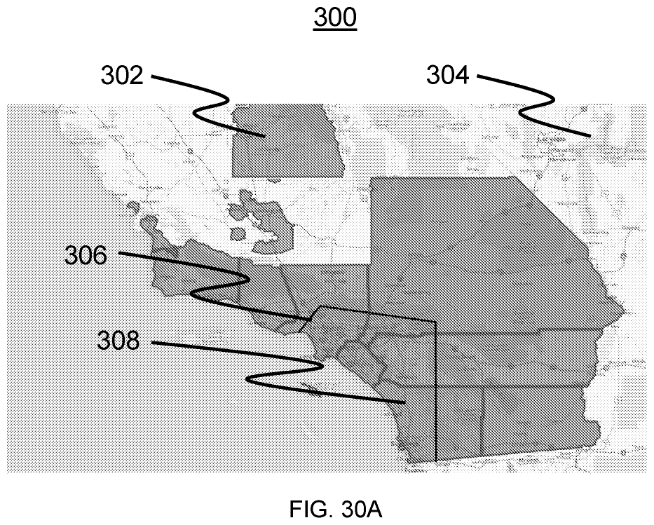

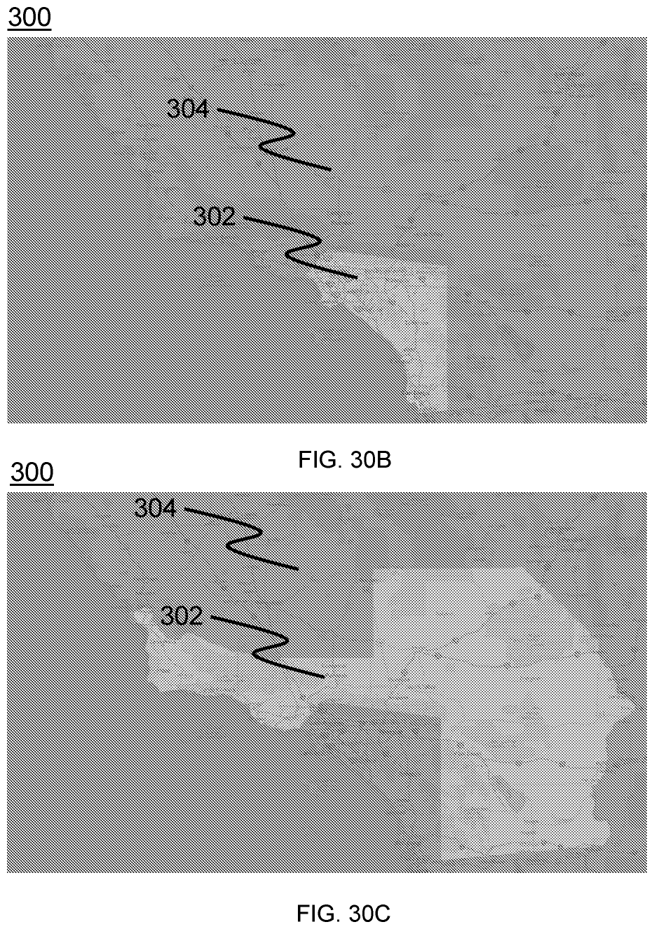

FIG. 30A shows another example quarantine map 300 of how a quarantine could be implemented and displayed to customers at retail nurseries. A black boundary 306 is shown that divides the state of California into two portions. One portion 308 includes the clusters of locations with inconclusive HLB test results. The other portion 304 includes the rest of the state. Also shown in red 302 are the existing ACP quarantined areas. This boundary line can be used as a first quarantine condition in combination with the existing ACP quarantined areas as a second quarantine condition. The black boundary could prohibit all movement across the boundary or it could allow one-way movement across the boundary. Since the highest danger is from the Los Angeles side with the inconclusive HLB test results, the boundary would prohibit movement from the Los Angeles side to the rest of the state. FIG. 30B shows an example of a map 300 that could be displayed to a retail nursery customer on the Los Angeles side of the boundary, showing a first area 302 where movement is permitted and a restricted area 304 where movement is prohibited. FIG. 30C shows an example of a map 300 that could be displayed to a retail nursery customer on the other side of the boundary if the boundary prevented movement in both directions, showing a first area 302 where movement is permitted and a restricted area 304 where movement is prohibited. If the boundary prevented movement only from the Los Angeles side, then a map such as the one in FIG. 23 could be displayed to a retail nursery customer on the other side of the boundary (for example, a customer in Santa Barbara).

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

What is claimed is:

1. A technical system for providing plant quarantine information to a user, the system comprising:
a quarantine tag with an informational link, the quarantine tag associated with a plant; and
a portable electronic device containing location-specific and user-specific information, and capable of receiving the informational link and generating a request for quarantine information based upon the informational link;
a quarantine server receiving the request for quarantine information along with location-specific information and user-specific information, and generating user-specific quarantine information for transmission and display to the user on the portable electronic device.

2. The technical system of claim 1, wherein the informational link is a hyperlink to an internet website.

3. The technical system of claim 1, wherein the informational link is a QR code.

4. The technical system of claim 1, wherein the informational link is an RFID tag.

5. The technical system of claim 1, wherein the portable electronic device displays user-specific quarantine information in the form of an interactive quarantine map to the user displaying a location of the user on the map with respect to a quarantine zone.

6. The technical system of claim 5, wherein the interactive quarantine map displays a location of a destination for the plant with respect to the quarantine zone.

7. A method of managing plant quarantines, comprising the steps of:
determining quarantine conditions at a location of a user;
obtaining a permitted area of plant movement for each of the quarantine conditions;
combining the permitted areas for the quarantine conditions;
generating an overall restricted area of plant movement for the location of the user based on the combined permitted areas; and
displaying the overall restricted areas to the user.

8. The method of claim 7, wherein the permitted areas include an area of high risk of spread of a disease.

9. The method of claim 7, further comprising displaying the overall restricted areas to the user based on a destination for a plant associated with the quarantine conditions.

10. A quarantine tag comprising:
a symbol area displaying a symbol associated with caution or warning;
a quarantine warning area displaying a written quarantine warning in a plurality of languages along with a hyperlink to a website in each of the plurality of languages;
a computer-readable code containing quarantine information;
a quarantine map area displaying a map of a quarantine zone for a plant associated with the quarantine tag.

11. The quarantine tag of claim 10, wherein the computer-readable code is a QR code.

12. The quarantine tag of claim 10, further comprising an RFID tag which wirelessly transmits the quarantine information to a portable electronic device.

13. The quarantine tag of claim 10, wherein the quarantine tag is red.
